(19) United States
(12) Patent Application Publication
(10) Pub. No.: US 2026/0238493 A1
(43) Pub. Date: Aug. 13, 2026

(54) DIGITAL WITNESS SYSTEMS AND METHODS FOR AUTHENTICATING AND CONFIRMING THE INTEGRITY OF A DIGITAL ARTIFACT

(71) Applicant: New York University, New York, NY (US)

(72) Inventors: Abhijit CHITNIS, Belle Mead, NJ (US); William DOCKERY, Powell, OH (US); NFN JIGYASA, Rego Park, NY (US)

(21) Appl. No.: 19/639,702

(22) Filed: Apr. 6, 2026

Related U.S. Application Data
(63) Continuation-in-part of application No. 18/101,105, filed on Jan. 24, 2023.
(60) Provisional application No. 63/302,889, filed on Jan. 25, 2022.

(51) Int. Cl. H04L 9/32; G06F 21/64; H04L 9/00; H04L 9/08

(52) U.S. Cl. CPC H04L 9/3247; G06F 21/64; H04L 9/0825; H04L 9/3236; H04L 9/50

(57) ABSTRACT

Digital Witness is a solution based on advanced cryptographic techniques to ensure data integrity, authenticity, irrefutability and confidentiality at the point of data creation. The DigiWit process guarantee is based on using strong cryptographic techniques in conjunction with PKI and public/private block-chains. DigiWit process establishes a ‘root of trust’ for a digital artifact in conjunction with notarization provided by a trusted third-party. The result is a mathematical non-repudiable guarantee that the file under audit is exactly as recorded by the author. The authenticity of the author and the root of trust are provided by the notarizing trusted third-party. Integrity of the captured data is based on the time to insert its unique signature to the block-chain public ledger. This root of trust is intended to be permissible to prove authenticity of evidence in the legal arena (e.g., images of crime scenes, contracts, etc.) based on mathematical veracity.

### § 0. RELATED APPLICATION(S)

This application is a continuation-in-part of U.S. patent application Ser. No. 18/101,105 (referred to as “the '105 application” and incorporated herein by reference), titled “DIGITAL WITNESS SYSTEMS AND METHODS FOR AUTHENTICATING AND CONFIRMING THE INTEGRITY OF A DIGITAL ARTIFACT”, filed on Jan. 24, 2025, and listing Abhijit CHITNIS, William DOCKERY, and Nfn JIGYASA as the inventors, the '105 application claiming the benefit of U.S. Provisional Application No. 63/302,889 (referred to as “the '889 provisional” and incorporated herein by reference), titled “DIGITAL WITNESS SYSTEMS AND METHODS FOR AUTHENTICATING AND CONFIRMING THE INTEGRITY OF A DIGITAL ARTIFACT,” filed on Jan. 25, 2022, and listing Abhijit CHITNIS, William DOCKERY, and Nfn JIGYASA as the inventors. The scope of the invention is not limited to any requirements of the specific embodiments in the '105 application or the '889 provisional.

### § 1. BACKGROUND

### § 1.1 Field of the Invention

The present invention concerns cybersecurity, and in particular, concerns authenticating and confirming the integrity of an instance of a digital work product (also referred to as a “digital artifact”).

### § 1.2 Background Information

There are many instances in which it would be useful to be able to verify the origin and data integrity of a digital artifact. It would be useful to provide a system that establishes a “root of trust.” Existing systems have one or more vulnerabilities. Therefore, it would be useful to provide a system for authenticating and confirming the integrity of an instance of a digital artifact, and which has reduced vulnerabilities.

### § 2. SUMMARY OF THE INVENTION

The challenge of authenticating and confirming the integrity of an instance of a digital artifact is solved by providing a method comprising: (a) receiving a digital artifact; (b) creating a digital fingerprint from the digital artifact; (c) generating or receiving authentication information associated with a creator; (d) transmitting, associated information including either (A)(1) the digital artifact, (2) the digital fingerprint, and (3) the authentication information associated with the creator, or (B)(1) the digital artifact, and (2) the digital fingerprint, both processed by the authentication information associated with the creator, as a first information set, to a digital notary; (e) receiving, by the digital notary, the first information set; (f) determining, by the digital notary, that the first information set originated from the creator using authentication; (g) responsive to a determination that the first information set originated from the creator, determining, by the digital notary, whether or not the digital artifact has integrity using the digital fingerprint; (h) responsive to determining that the digital artifact has integrity, digitally signing, by the digital notary, the digital fingerprint, to generate a bonded fingerprint including a digital signature uniquely associated with the digital notary, wherein the bonded fingerprint includes a time stamp and/or a date stamp; and (i) storing the bonded fingerprint on an immutable decentralized ledger registry.

In some example methods consistent with the present description, the act of creating a digital fingerprint includes hashing the digital artifact.

In some example methods consistent with the present description, the digital artifact includes digital content and at least one of (A) a watermark and (B) meta data.

In some example methods consistent with the present description, the authentication information associated with the creator is a private key, and wherein the private key has an associated public key. In at least some such example methods, the act of determining, by the digital notary, that the first information set originated from the creator using authentication uses the public key and the private key.

In some example methods consistent with the present description, the bonded fingerprint is generated by encrypting the fingerprint with a private key of the digital notary.

In some example methods consistent with the present description, the immutable decentralized ledger registry is a blockchain.

In some example methods consistent with the present description, the bonded fingerprint is stored to the immutable decentralized ledger by the digital notary.

In some example methods consistent with the present description, the act of storing the bonded fingerprint on an immutable decentralized ledger registry includes (1) transmitting the bonded fingerprint from the digital notary to a user device of the creator, and (2) storing the bonded fingerprint from the user device of the creator to the immutable decentralized ledger.

Some example methods consistent with the present description further include: determining, by an auditing service provider, whether or not a copy of the digital artifact has data integrity, by retrieving the bonded fingerprint from the immutable decentralized ledger; authenticating that the digital signature of the bonded fingerprint is uniquely associated with the digital notary; creating a digital fingerprint copy from the copy of the digital artifact; and comparing the digital fingerprint copy created with the bonded fingerprint.

Systems and/or devices for performing some or all of the foregoing parts of the example method are also provided.

### § 3. BRIEF DESCRIPTION OF THE DRAWINGS

FIG. 1 illustrates an environment in which an example system consistent with the present description is implemented.

FIGS. 2A-2C are flow diagrams of example methods for performing digital notary processing, creator processing, and registrar processing, respectively, in a manner consistent with the present description.

FIG. 3 illustrates an example of data structures used in the example methods of FIGS. 2A-2C.

FIG. 4 is a flow diagram of an example method for performing validation and authentication processing, in a manner consistent with the present description.

FIG. 5 is a diagram illustrating operations of a validation and authentication system consistent with the present description.

FIGS. 6A-6C illustrate example data structures used in the example system of FIG. 5.

FIG. 7 is a detailed diagram illustrating operations of a validation and authentication system consistent with the present description.

FIGS. 8A-8L illustrate and explain symbols and legends used in FIG. 7.

FIG. 9 is an example machine which may be used to implement methods consistent with the present description, and to store information or data consistent with the present description.

FIGS. 10A-10E are example user interface screens for navigating to an image, selecting an image, storing the selected image with a digital fingerprint, and requesting a notary to digitally sign the image in an example mobile application.

FIG. 11 illustrates example database record information about the image selected and stored (but not yet notarized) in the example of FIGS. 10A-10E.

FIGS. 12A and 12B are example user interface screens illustrating icons for showing the status of a given image, and FIGS. 12C and 12D are example user interface screens for requesting the image to be “signed” by a digital notary, in an example mobile application.

FIG. 13 illustrates database record information about the selected image that has been stored and signed by a digital notary.

FIGS. 14A and 14B are example user interface screens illustrating icons for showing the updated, current status of the given image, and for requesting that the signed image be stored with a registrar, such as in an irrefutable ledger.

FIG. 15 illustrates database record information about the selected, signed, and registered image.

FIGS. 16A and 16B are flow diagrams of an example “zero knowledge” implementation of methods consistent with the present description.

FIGS. 17A-17F illustrate operations in an example “zero knowledge” implementation of an example method consistent with the present description.

FIG. 18 is a flow diagram of an example “receipting” extension to example methods consistent with the present description.

FIG. 19 illustrates operations in an example “receipting” extension to example methods consistent with the present description.

FIGS. 20A-20F illustrate operations in an example “breadcrumb” extension to example methods consistent with the present description.

### § 4. DETAILED DESCRIPTION

Example embodiments consistent with the present description may involve novel methods, apparatus, message formats, and/or data structures for authenticating and checking the integrity of a digital work product (also referred to as a “digital artifact”). The following description is presented to enable one skilled in the art to make and use the invention, and is provided in the context of particular applications and their requirements. Thus, the following description of embodiments consistent with the present description provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

An example process described includes three main parties or components. A “creator” is responsible for creating the digital artifact (including any required meta data appropriate for future (potentially legal) use). A “digital notary” acts as a trusted witness and digital signatory to the digital artifact, and as a validator for the creator's identity and authenticity. The digital notary may sign and timestamp the digital artifact (or a fingerprint thereof) to generate a “bonded file. Finally, a “registry” (e.g., lock-chain ledger) stores the unique timestamped digital fingerprint of the bonded file as an irrefutable record of events.

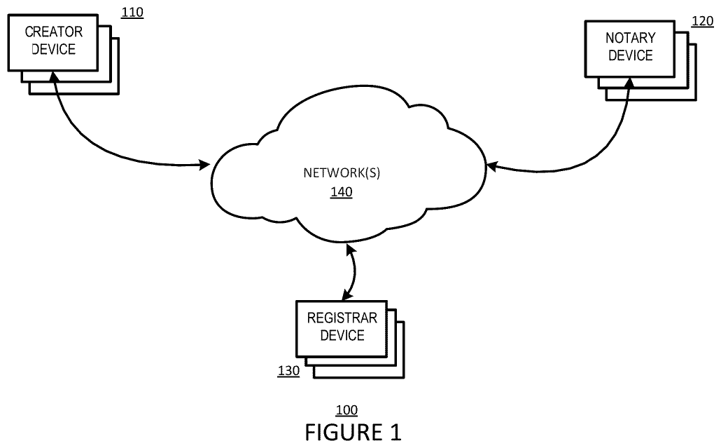

FIG. 1 illustrates an example environment 100 in which an example system consistent with the present description is implemented. As shown, the example environment 100 includes one or more creator device(s) 110, one or more notary device(s) 120, and one or more registration device(s) 130. These devices may communicate with one another and exchange data via one or more network(s) 140, such as the Internet for example.

### § 4.1 Glossary

“Authentication” is the process of verifying the identity or other attributes of an entity (e.g., a user, a process, or a device). It may also refer to the process of verifying the source and integrity of data.

“Authenticity” is a property achieved through cryptographic methods of being genuine and being able to be verified and trusted, resulting in confidence in the validity of a transmission, information or a message, or sender of information or a message.

“Data integrity” is the property that data is complete, intact, and trusted and has not been modified or destroyed in an unauthorized or accidental manner. For example, “digital integrity” is the condition that a digital artifact has not been altered in any way since it was “digitally witnessed.”

“Hashing” is a process of applying a mathematical algorithm against a set of data to produce a numeric value (that is, a “hash value”) that represents the data. “Hashing” may mean mapping a bit string of arbitrary length to a fixed length bit string to produce the hash value. Typically, the original bit string cannot be derived (solely) from the hash value.

“Integrity” is the property whereby information, an information system, or a component of a system has not been modified or destroyed in an unauthorized manner. “Integrity” may also mean a state in which information has remained unaltered from the point it was produced by a source, during transmission, storage, and eventual receipt by a destination.

A “key” is the numerical value used to control cryptographic operations, such as decryption, encryption, signature generation, or signature verification. A “private key” is a cryptographic key that must be kept confidential and is used to enable the operation of an asymmetric (public key) cryptographic algorithm. That is, a private key is a secret part of an asymmetric key pair that is uniquely associated with an entity. A “public key” is a cryptographic key that may be widely published and is used to enable the operation of an asymmetric (public key) cryptographic algorithm. That is, a public key is the public part of an asymmetric key pair that is uniquely associated with an entity and that may be made public.

A “key pair” is a public key and its corresponding private key. For example, a “key pair” may be two mathematically related keys having the property that one key can be used to encrypt a message that can only be decrypted using the other key.

“Non-repudiation” is a property achieved through cryptographic methods to protect against an individual or entity falsely denying having performed a particular action related to data. “Non-repudiation” may provide the capability to determine whether a given individual took a particular action such as creating information, sending a message, approving information, and receiving a message.

“Digital Witnessing” is a process whereby the condition (state) of a digital artifact is baselined and made verifiable as unmodified or unmodified (i.e., no longer in the baselined condition).

A “creator” is responsible for creating the digital artifact (including any required meta data appropriate for future (potentially legal) use). A “creator” may also be referred to as a “recorder”, representing a person interested in capturing the state of a digital artifact. Generally, the creator will be an entity interested in capturing the point-in-time state of a digital artifact (e.g., crime scene investigation photographer, news photographer, mobile journalist, etc.). Generally, the creator will depend on the use case.

A “digital notary” acts as a trusted witness and digital signatory to the digital artifact, and as a validator for the creator's identity and authenticity. The digital notary may sign and timestamp the digital artifact (or a fingerprint thereof) to generate a “bonded file.” Therefore, a digital notary may be thought of as a validation and authentication service provider, and will generally be a trusted third party. An “ADN” is an automated digital notary.

A “digital notary service provider or facilitator” or “digital notary service provider/facilitator” (digital witness—DW) may digitally sign/notarize a digital artifact (or breadcrumb, or some other data) itself, or a derivative (e.g., a fingerprint (e.g., hash)) thereof, or may act as a facilitator for digitally signing/notarizing by an independent third party.

An “IDP” or “identity provider” is a service provider that provides evidence that a given user is authenticated.

A “registry” (e.g., lock-chain ledger) stores the unique timestamped digital fingerprint of the bonded file (which may, but need not, include the original digital artifact) as an irrefutable record of events.

A “registrar” is a third-party component of digital witnessing that ensures chain-of-trust/digital chain-of-custody when a digital artifact is compared against bonded file data

A “Digital Artifact” is any combination of digital data provided in one or more digital files. Examples of digital artifacts include, but are not limited to, documents which could represent text files, image files, drawing files, audio, video, static graphic, music (sound), contracts, books/media, etc. Therefore, a “digital artifact” can be understood to be a digital work product. It is not intended to mean a defect in capturing and/or processing digital data. A “digital artifact” may include meta data, but this is not necessary. Therefore, for example, meta data may be added to an initial digital artifact to generate a new digital artifact.

Digital Fingerprinting—using a combination of one or more encryption technologies to create a claim upon a digital artifact (e.g., ownership, as creator, as witness, etc.)

A “Bonded File” is a file that has a creator's digital fingerprint, and has been witnessed by a digital notary

A “Candidate File” is a digital artifact (which may, though need not, include meta-data) that has been digitally fingerprinted by the creator/recorder

“Meta-Data” are one or more parameters and/or conditions data added to the digital artifact (thereby creating a new or tagged digital artifact) to be used later to enhance the claims against the digital artifact.

A “Digital Chain of Custody” or “Digital Chain of Trust” provides cryptographic proof, or a high level of cryptographic certainty, that a digital artifact is identical to the state it was in when first digitally witnessed.

“DigiWitness™” or “DigiWitnessing™” is an action (implicit due to installed app or explicit by user) taken to insert digital artifact in the described chain of custody.

DigiWitnessed™—A digital artifact that was added to the described chain of custody.

### § 4.2 Example Methods and Data Structures

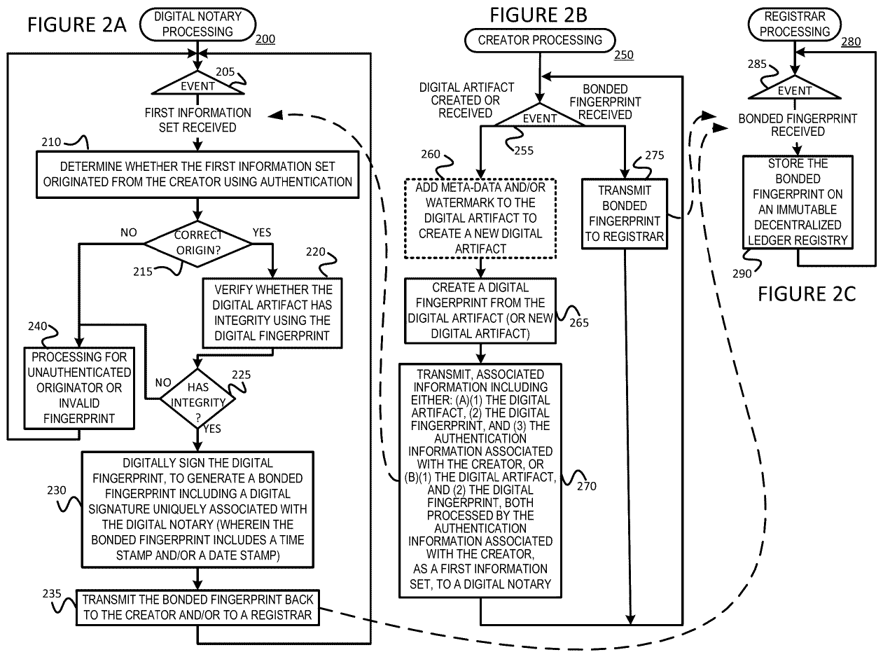

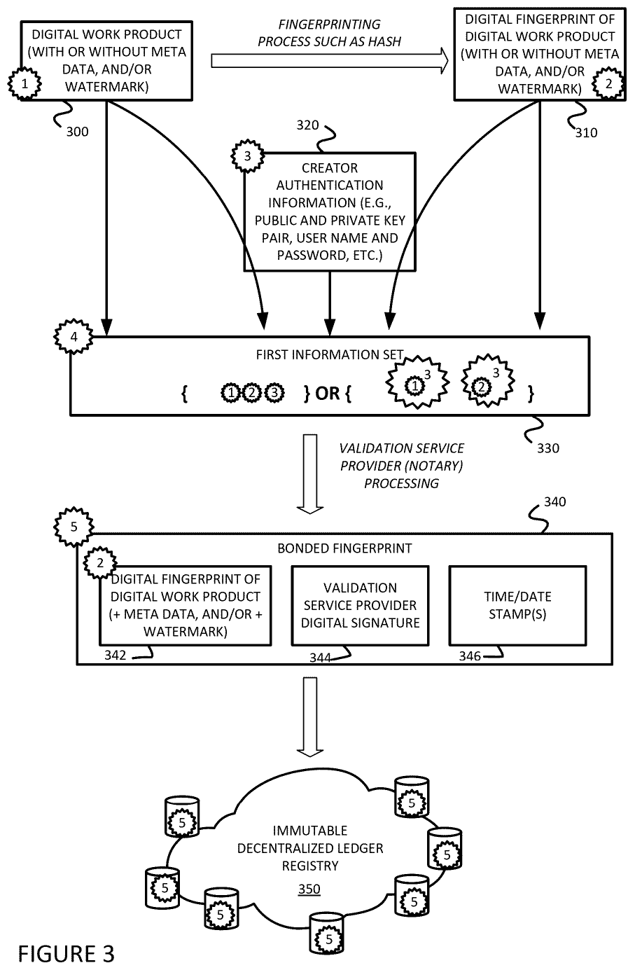

FIGS. 2A-2C are flow diagrams of example methods 200, 250, and 280, respectively, for performing digital notary processing, creator processing, and registrar processing, respectively, in a manner consistent with the present description. FIG. 3 illustrates an example of data structures used in the example methods of FIGS. 2A-2C.

Referring first to example method 250 of FIG. 2B, different branches of the example method 250 are performed in response to the occurrence of different events. (Event branch 255) For example, if a digital artifact is created or otherwise received, the left branch of the example method 250 is performed. More specifically, meta data and/or a watermark may be added to the digital artifact to create a new digital artifact. (Block 260) Then, the example method 250 creates a digital fingerprint from the digital artifact (or from the new digital artifact including the meta data and/or watermark). (Block 265) FIG. 3 illustrates the transition of a digital artifact 300 to a fingerprint of the digital artifact 310. Although not shown, the example method 250 may also generate or receive authentication information associated with a creator. See also, creator authentication information 320 of FIG. 3. (This information may be used later to authenticate that the digital artifact was provided by the creator.) Finally, the example method transmits to a digital notary, associated information including either (A)(1) the digital artifact, (2) the digital fingerprint, and (3) the authentication information associated with the creator, or (B)(1) the digital artifact, and (2) the digital fingerprint, both processed by the authentication information associated with the creator, as a first information set. (Block 270) Referring to FIG. 3, this is represented by first information set 330.

Referring now to example method 200 of FIG. 2A, responsive to the first information set being received by the digital notary (Event 205), the example method 200 determines whether or not that the first information set originated from the creator using authentication. (Block 210) Responsive to a determination that the first information set originated from the creator (Decision 215=YES), the example method 200 determines whether or not the digital artifact has integrity using the digital fingerprint. (Block 220) Responsive to determining that the digital artifact has integrity (Decision 225=YES), the example method 200 digitally signs the digital fingerprint, to generate a bonded fingerprint including a digital signature uniquely associated with the digital notary. (Block 230) Referring to FIG. 3, the bonded fingerprint 340 includes a digital fingerprint of the digital artifact 342 and a notary digital signature 344, and may also include a time stamp and/or a date stamp 346. Finally, the example method 200 transmits the bonded fingerprint either to the creator from which the first information was received, or to a digital registrar. (Block 235) Referring to block 240, if it is determined that the first information set did not originate from the creator (Decision 215=NO), or that the digital artifact cannot be validated as having integrity (Decision 225=NO), the example method 200 performs processing for unauthenticated creator and/or invalid fingerprint. This might include transmitting an error message and/or logging an error event.

Referring back to event 255 of FIG. 2B, if the bonded fingerprint is sent to the creator, the example method 250 transmits the bonded fingerprint to a digital registrar. (Block 275) Otherwise, the bonded fingerprint can be sent directly from the digital notary process to a digital registrar. Referring to example method 280 in FIG. 2C, responsive to receiving a bonded fingerprint, the example method 280 stores the bonded fingerprint on an immutable decentralized ledger registry. (Block 290) Referring to FIG. 3, this is illustrated by element 350.

Referring back to block 265 of FIG. 2B, in some example implementations, the act of creating a digital fingerprint includes hashing the digital artifact.

Referring back to 320 of FIG. 3, in some example implementations, the authentication information associated with the creator is a private key, which has an associated public key. In such example implementation(s), referring back to 210 of FIG. 2A, the act of determining, by the digital notary, that the first information set originated from the creator using authentication may use the public key and the private key.

Referring back to block 230 of FIG. 2A, in some example implementations, the bonded fingerprint is generated by encrypting the fingerprint with a private key of the digital notary.

Referring back to block 290 of FIG. 2C, and to element 350 of FIG. 3, in some example implementations, the immutable decentralized ledger registry is a blockchain. Note that if the bonded fingerprint is generated using a hash function, it may have a fixed size. Further, this fixed size might be much smaller than the original digital artifact. Consider a long, high-resolution video file for example. A technical problem of storing files on a blockchain is that it is quite inefficient in terms of storage and data processing. Therefore, storing a fixed size file which is much smaller than the original digital artifact both exploits advantages of blockchain technologies, while also minimizing inherent inefficiencies of blockchain technologies. This smaller, fixed, size provides better performance in terms of storage, and/or retrieval.

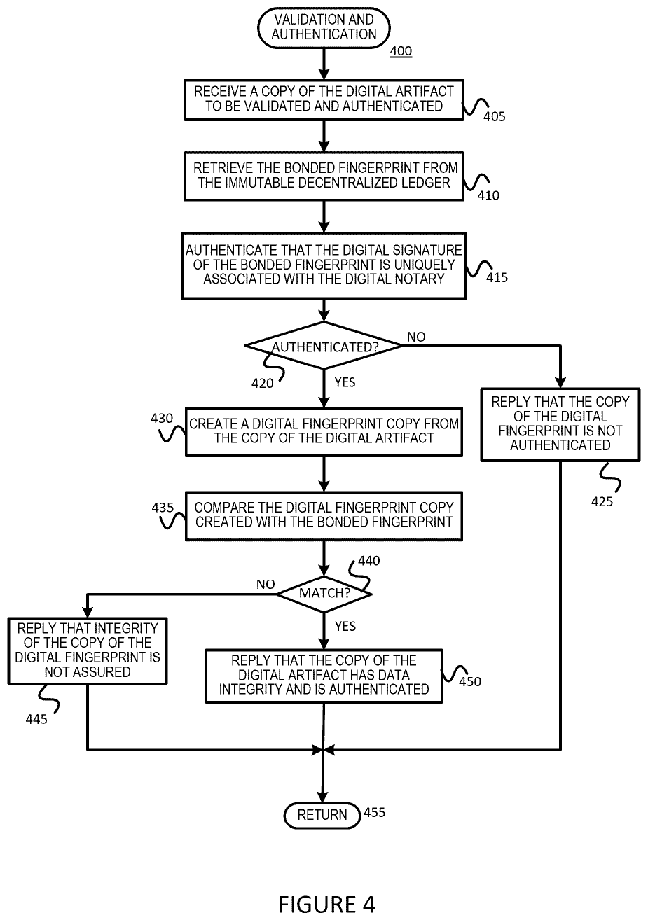

FIG. 4 is a flow diagram of an example method 400 for performing validation and authentication processing, in a manner consistent with the present description. As shown, the example method 400 receives a copy of the digital artifact to be validated and authenticated. (Block 405) The example method 400 may then retrieve the bonded fingerprint from the immutable decentralized ledger. (Block 410) The example method 400 may then authenticate that the digital signature of the bonded fingerprint is uniquely associated with the digital notary. (Block 415) If the example method 400 authenticates that the digital signature of the bonded fingerprint is uniquely associated with the digital notary (Decision 420=YES), it creates a digital fingerprint copy from the copy of the digital artifact (Block 430) and compares the digital fingerprint copy created with the bonded fingerprint. (Block 435) If the digital fingerprint copy created matches the bonded fingerprint (Decision 440=YES), then the example method 400 may reply (e.g., to a requestor) that the copy of the digital artifact has data integrity and is authenticated (Block 450), before the method is left (Return node 455).

Referring back to decision 420, if, on the other hand, the example method 400 does not authenticate that the digital signature of the bonded fingerprint is uniquely associated with the digital notary (Decision 420=NO), it may provide a reply (e.g., to the party requesting validation and authentication) that the copy of the digital fingerprint is not authenticated (Block 425) before the example method 400 is left (Return node 455). Referring back to decision 440, if, on the other hand, the digital fingerprint copy created does not match the bonded fingerprint (Decision 440=NO), then the example method 400 may reply (e.g., to a requestor) that data integrity of the digital artifact is not assured (Block 445), before the method is left (Return node 455).

Although not shown, the authentication and data integrity validation steps may be combined. For example, this might be done if the digital fingerprint was generated using the notary's digital signature.

### § 4.3 Example System Components and their Operations

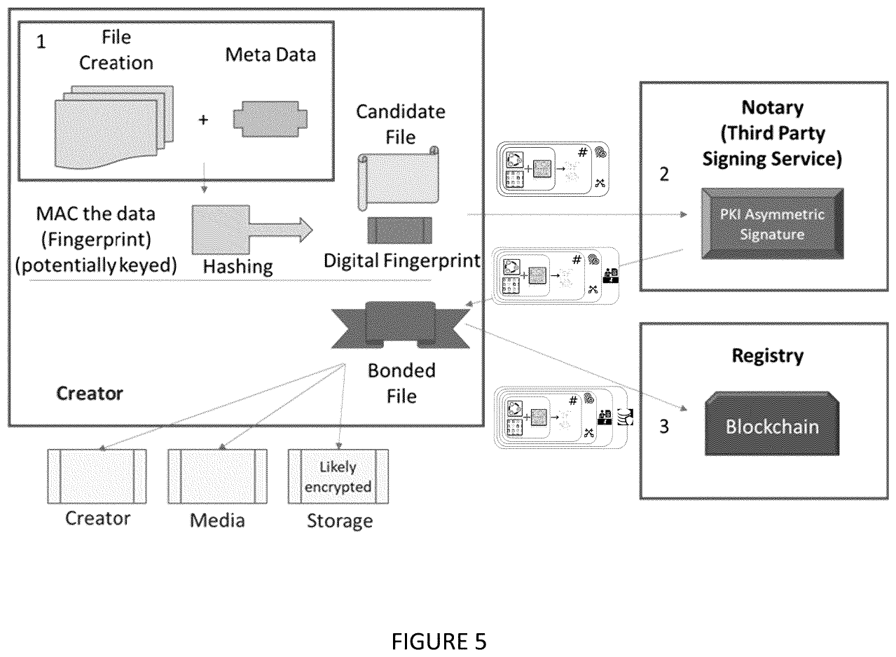

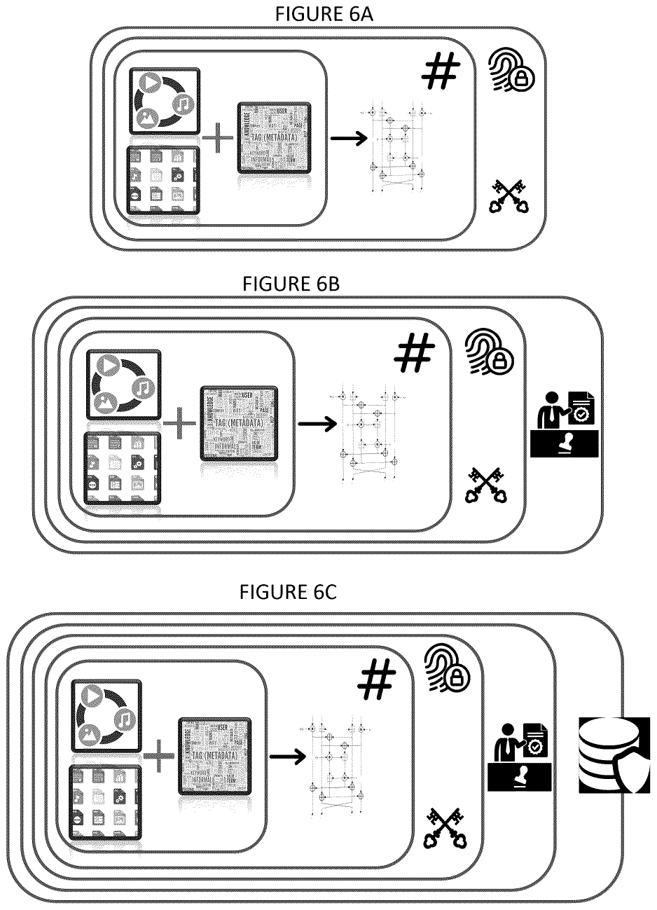

FIG. 5 is a diagram illustrating operations of a validation and authentication system consistent with the present description. FIGS. 6A-6C illustrate example data structures used in the example system of FIG. 5.

Referring to FIG. 5, the creator device creates or acquires a digital artifact they'd like to ensure is catalogued, maintains integrity for the length of validity of the crypto techniques applied and can be attributed to the creator irrefutably. In this example, the creator device optionally appends a water-mark and/or metadata supporting the intended use. For example, in the case of a photographer, added metadata may include camera make/model/SN, timestamping, geolocation data, case number, etc.). The digital artifact is (one-way) hashed to create a digital fingerprint and a Message Authentication Code (MAC). The digital artifact is now associated with the specific environment of its production or acquisition. Hashing ensures the image state is locked. The digital fingerprint is then signed using the creator's private key. The signed digital artifact bundle 510 (See also FIG. 6A.) is then forwarded to the to the third-party notary device/system for digital witnessing or notarization (signing).

The notary device or system validates the received artifact by verifying the creator's identity using the creator's CA Cert which is part of the payload 510 received by the notary device/system. In this example, the notary service has its own multifactor authentication for the creator to log in and validate identity. The third-party trusted notary appends data necessary to assure the signing event (e.g., timestamping, transaction number, etc.) and digitally signs the combined data.

The notary device/system returns the resulting “bonded artifact” or “bonded fingerprint” 520 (See also FIG. 6B.), which is a hashed (fixed length) fingerprint of the original digital artifact digitally signed by the creator and digitally notarized (i.e., digitally signed) by a trusted third-party.

The “bonded artifact” or “bonded fingerprint” 520 is then inserted into a consensus based public or private blockchain “registry” device or system as a “record of event.” It may be timestamped as of the insertion time. (See, e.g., 530 in FIGS. 5 and 6C.) The original digital artifact may be stored locally and/or on the cloud (e.g., based on the creator's subscription).

When the data integrity and authentication (also referred to as “validity”) of the file is in question, an auditing party can leverage the “bonded artifact” or “bonded fingerprint” retrieved from the block-chain ledger to both (1) validate the notary signature, and (2) recalculate the hash of the candidate file for comparison with the bonded fingerprint. These checks can be used to gives confidence (based, at least in part, on the mathematical probabilities implied by the hashing) that should the validation process succeed, the artifact in question may be deemed identical in all respects to the digital artifact (digital fingerprint) stored in the block-chain ledger.

Advantageously, if the notary's public key infrastructure (PKI) become compromised, the blockchain registry acts as the mediator to ensure the state of the bonded file information and notary at the time of registration.

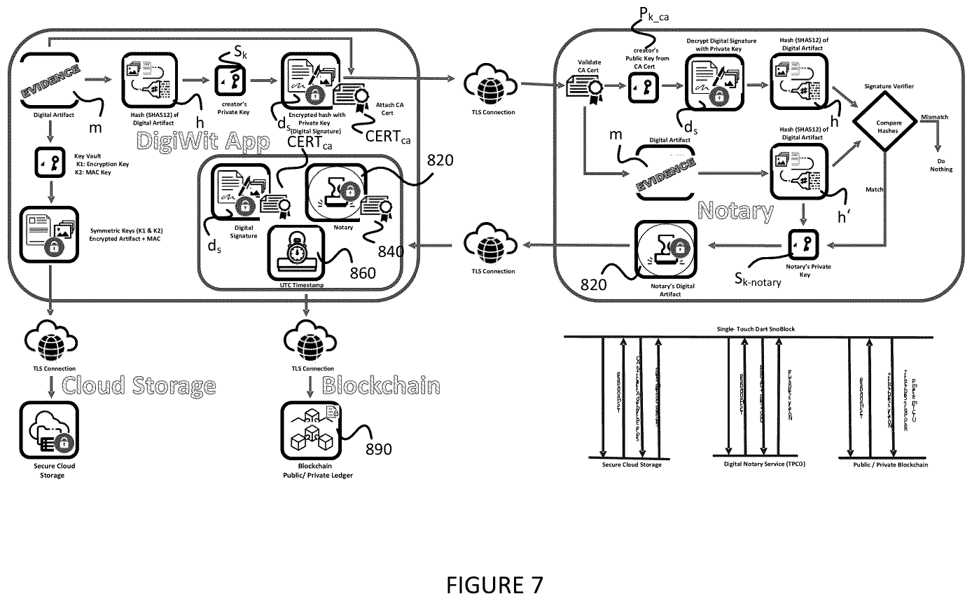

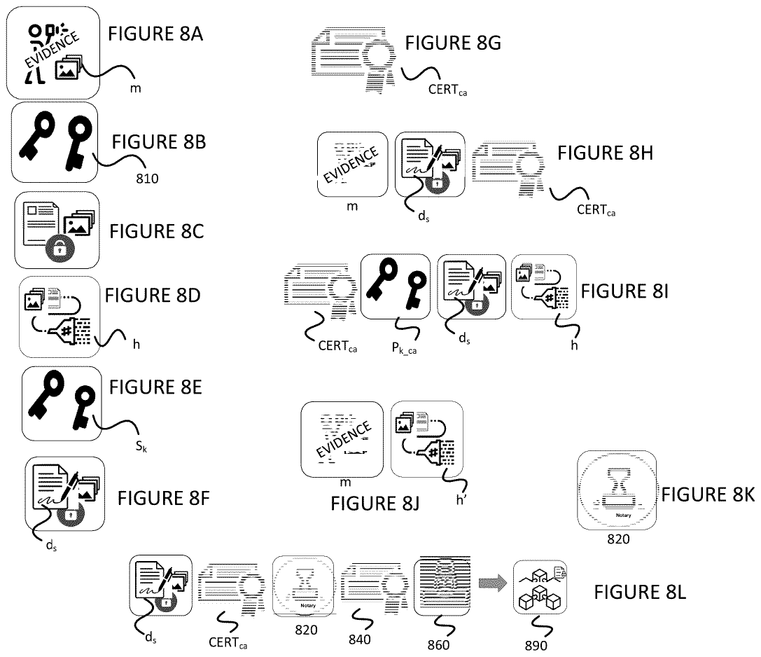

FIG. 7 is a detailed diagram illustrating operations of a validation and authentication system consistent with the present description. FIGS. 8A-8L illustrate and explain symbols and legends used in FIG. 7. FIG. 8A depicts a plaintext digital artifact which may be a text, formatted text, image, audio, video, or any other type of binary file. Based on an example forensic application described here, we call it the “evidence”. Typically, this evidence is augmented with context specific metadata. Let's represent this augmented plaintext as m.

Referring to FIG. 8B, the next step is to save it securely to the cloud to prevent a single local copy of the evidence from being destroyed; either accidentally or maliciously. For this purpose, the artifact is encrypted using a private (symmetric) key 810 fetched from a key vault, either local or managed by a third party. More specifically, two keys (k₁ and k₂) are generated for the purposes of encryption and then generating a MAC. Encryption ensures confidentiality and MAC ensures integrity under certain assumptions. Let c represent the ciphertext or encrypted message and t represent the tag (MAC). Let r₁ and r₂ be two pseudo-random numbers generated by the system to generate two symmetric keys. The random numbers r₁ & r₂ associated with the keys k1 & k2 will be stored in a separate key vault. Thus, k₁=KeyGen(k, r₁), k₂=KeyGen(k, r₂), c=Enc(m, k₁), and t=TagGen(c, k₂)

Referring next to FIG. 8C, the next step is to save it securely to the cloud to prevent a single local copy of the evidence from being destroyed either accidentally or maliciously. For this purpose, the artifact is encrypted using a private (symmetric) key fetched from a key vault either local or managed by a third party.

Referring next to FIG. 8D, plaintext m is hashed using SHA512 to generate a reproducible fingerprint h of the original document, where h=SHA512(m).

Referring next to FIG. 8E, the creator's Private Key, Sₖ, is fetched from the key vault and used to digitally sign the original document.

Referring now to FIG. 8F, let's call the digital signature ds. This digital signature is generated by encrypting the hash h using private key Sₖ, where ds=Enc(h, Sₖ).

Referring next to FIG. 8G, a creator's certificate issued by a valid Certificate Authority ((CA), e.g., Verisign) is used to authenticate the creator by third parties such as a notary. Let's call the certificate CERT_{ca}. Such a certificate is issued by a CA after due verification of the identity of the individual or legal entity for whom the cert. is issued. CA certificates are encrypted using the CA's private key.

Referring now to FIG. 8H, the plaintext document m, digital signature dₛ and CA cert CERT_{ca} are sent to the notary server for notarization via a transport layer security (TLS) connection.

In FIG. 8I, a notary service verifies the CA certification CERT_{ca} received from the creator by using the CA's public key P_{k_ca} (freely available) to extract the creator's public key Pₖ. This is used to decrypt the creator's digital signature dₛ to extract the hash h generated by the creator, where Pk=Vrfy (CERT_{ca}, P_{k_ca}) and h=Dec (ds, P).

Referring to FIG. 8J, the notary service verifies the creator's hash h by reproducing another hash h′ from the plaintext document m received for notarization, where h′=SHA512(m). Referring next to FIG. 8K, in this example, h and h′ must be identical for the notarization to proceed. If h and h′ are not identical, an error code is transmitted back to the creator. Notarization includes encrypting the validated plaintext hash h with the notary's private key S_{k-notary} to produce a notarized signature 820 of the original document represented by n. This notarized signature n is sent back to the creator for safe keeping. Thus, if h-h′, then n=Enc(h, S_{k-notary}), else n=Error(tampered_doc).

Finally, referring to FIG. 8L, upon successful notarization, creator proceeds to create an immutable record of the notarized document by inserting the recorder's digital signature, the creator's CA certification, notarized signature 820, notary's CA certification 840 along with the current UTC timestamp 860 to a public or private legally admissible blockchain 890. That is, insert to BlockChain (ds, CERT_{ca}, n CERT_{notary}, timestamp).

Fourteen steps explaining the operations of this system are described in §§ 4.3.1-4.3.14 below.

### § 4.3.1 Creator's Device: Generate Digital Artifact

The creator captures a digital artifact using any available native application on the mobile device. The digital artifact may be an audio, video, image, or any other text or encoded/formatted file in any standard or proprietary digital format. Such a digital artifact is henceforth referred to as the plaintext document or plaintext digital artifact. Such a digital artifact may be captured as evidence for any event desired by the creator. The time elapsed between the actual event occurrence and the notarized digital artifact being stored in the block-chain ledger may be of prime importance during legal proceedings to reasonably rule out tampering and/or deep faking. Typically, this evidence is augmented with context specific metadata. Let's represent this augmented plaintext as m. (Recall, e.g., 250 of FIG. 2B.)

The digital artifact may also represent an idea, original article, or a contract between multiple parties that needs to be timestamped, digitally witnessed, saved immutably and indefinitely (e.g., in perpetuity) for future retrieval.

### § 4.3.2 DigiWit: Encrypt Using Creator's Private Key, Generate Authentication Tag (MAC), Backup to the Cloud

Next, the digital artifact should be saved securely to the cloud to prevent a single local copy of the evidence from being destroyed, either accidentally or maliciously. For this purpose, the artifact may be encrypted using a private (symmetric) key generated at this time and saved to an external cloud-based third-party key vault.

Two keys k₁ and k₂ are generated for the dual purposes of encryption and generating a MAC. Encryption ensures confidentiality and MAC ensures integrity under certain assumptions. Let c represent the ciphertext or encrypted message and t represent the tag (MAC). Let r₁ and r₂ be two pseudo-random numbers generated by the system to generate two symmetric keys. r₁ and r₂ associated with k1 and k2 will be stored in a separate key vault so as not to easily associated with k1 and k2 to reduce the risk of attacks.

$${k}_{1} = Key Gen ( k , {r}_{1} )$$

$${k}_{1} = Key Gen ( k , {r}_{2} )$$

$$c = Enc ( m , {k}_{1} ) t = Tag Gen ( c , {k}_{2} )$$

### § 4.3.3 DigiWit: Fingerprint Artifact

Plaintext m is hashed using SHA512 to generate a reproducible fingerprint h of the original document. (Recall, e.g., 265 of FIG. 2B.)

$$h = SHA 512 ( m )$$

Such a reproducible fingerprint will be used extensively in the DigiWit process for integrity checks, notarization, block-chain ledger insertion and future evidence veracity checks.

§ 4.3.4 DigiWit: Creator Signs the Artifact—Encrypt Fingerprint with Creator's Private Key

Creator's Private Key, SK_{rec} (from the private/public pair) is fetched from the key vault. This step assumes that the corresponding public key is registered with one of the trusted certificate authorities (“CAs”) and a CA Cert has been issued to the creator. (Recall, e.g., 265 and 270 of FIG. 2B.) If a public/private pair does not exist, it may be generated and saved to the local or cloud-based key vault. The (secret) private key SK_{rec} is then used to encrypt the fingerprint from § 4.3.3. The generated string is referred to as the verifiable signed artifact as the signatory's identity may be verified using the trusted CA Cert issued to the creator.

$${c}^{′} = Enc ( h , {SK}_{rec} )$$

### § 4.3.5 DigiWit: Create Payload to be Uploaded to Notary Via NaaS API

The record to be uploaded to the Notary via the network as a service (NaaS) API call is assembled by concatenating the plaintext document m, digitally signed fingerprint c′, and creator's CA Cert CA_{rec}. This combined payload is encrypted using the Notary's public key PK_{notary} before it is uploaded to the Notary. (Recall, e.g., FIGS. 5 and 6A.)

$$C - {Payload}_{notary} = Enc ( m \vert {c}^{′} \vert {CA}_{rec} , {PK}_{notary} )$$

### § 4.3.6 DigiWit: Trigger NaaS API and Upload Notary Payload

Upload notary payload created in § 4.3.5 to the intended Notary via a published NaaS API call for notarization. Fully automated digital notary services (NaaS) described here may be a novel functionality and such a service (NaaS) may need to be created. If that's the case, our process claim gains further credibility.

$${NaaS}_{upload} ( {UserID}_{rec} , {Cred}_{rec} , C - {Payload}_{notary} , SHA 512 )$$

### § 4.3.7 Notary: Verify Creator's Identity and Access Permission

Notary's server verifies the creator's (client's) identity and access permissions using the received credentials. (Recall, e.g., 210 and 215 of FIG. 2A.) MFA may be utilized here for added security. Cipher Payload (C-Payload_{notary}) is processed by the Notary as follows.

### § 4.3.8 Notary: Decrypt Payload and Validate Creator's CA Cert

Notary decrypts the received payload using its uncompromised private key SK_{notary}. Individual components of the payload are saved for validation.

$$M - {Payload}_{notary} = Dec ( C - {Payload}_{notary} , {PK}_{notary} ) \qquad i )$$

### § 4.3.9 Notary: Validate Artifact Integrity

Notary regenerates the (hash) fingerprint for the plaintext artifact m using the hashing algorithm provided via the Naas API call. Notary validates the creator's CA Cert and extracts the creator's public key to decode the transmitted fingerprint. Notarization process continues if the regenerated fingerprint matches the received fingerprint. (Recall, e.g., 220 and 225 of FIG. 2A.) If not, an error code is communicated back, and the process terminates. (Recall, e.g., 240 of FIG. 2A.)

### § 4.3.10 Notary: Notarize Artifact

Notary encrypts the validated artifact fingerprint with Notary's private key SK_{notary} and timestamps the transaction. The combined payload is then encrypted using the creator's public key PK_{rec}. (Recall, e.g., 230 of FIG. 2A, as well as FIGS. 5 and 6B.) The Notary also retains a copy of the notarized record with the timestamp in its own local or cloud-based ledger. This record may also be subpoenaed for legal validation, if necessary.

$${h}_{notary} = Enc ( h , {SK}_{notary} )$$

$$C - {Payload}_{rec} = Enc ( {h}_{notary} \vert timestamp , {PK}_{rec} )$$

### § 4.3.11 DigiWit: Receive Notarized & Timestamped Record

Digital Witness application receives the notarized payload from the Notary via the call back API call. This payload is decrypted using the creator's private key SK_{rec}.

§ 4.3.12 DigiWit: Verify Notarized Artifact with Local Fingerprint to Prevent MiTM Attack

For added security, DW application decrypts the notarized record using PK_{notary} and compares the signed fingerprint with its own copy of the artifact fingerprint. Ledger insertion is attempted upon validation of the notarized record. (Not shown in FIG. 2B.)

### § 4.3.13 DigiWit: Insert to Block-Chain Registry (Ethereum or Equivalent)

Insert the received and validated payload from the Notary to the public or private block-chain consensus-based ledger for perpetuity. (Recall, e.g., FIGS. 2C, 5, and 6C.) The Ethereum public block-chain charges a small transaction fee payable to the stakeholder executing the smart contract once the consensus to insert has been reached by majority stakeholders. This may take a few seconds or up to a minute. Once this new record is inserted into the block-chain it becomes immutable and may not be removed. On an Ethereum block-chain, this is achieved with the help of a smart contract.

### § 4.3.14 Evidence Veracity Check (at a Future Point in Time):

If there is a need to verify the artifact claimed to be an original account of a past event, the latest signed contract or an earlier idea in a dispute, the notarized record may be retrieved from the block-chain ledger with the insertion timestamp. The disputed artifacts may be fingerprinted and compared to the immutable fingerprint saved to the block-chain to determine if the file in question is the same as the file originally witnessed. This function may be executed by an independent auditor before passing judgement. (Recall, e.g., 430, 435, and 440 of FIG. 4.)

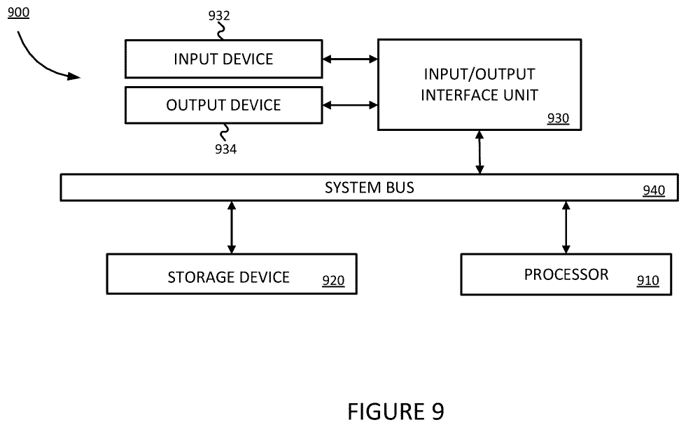

FIG. 9 is a block diagram of an example machine 900 that may perform one or more of the processes described, and/or store information used and/or generated by such processes. The example machine 900 includes one or more processors 910, one or more input/output interface units 930, one or more storage devices 920, and one or more system buses and/or networks 940 for facilitating the communication of information among the coupled elements. One or more input devices 932 and one or more output devices 934 may be coupled with the one or more input/output interfaces 930. The one or more processors 910 may execute machine-executable instructions (e.g., C or C++ running on the Linux operating system widely available from a number of vendors) to effect one or more aspects of the present description. At least a portion of the machine executable instructions may be stored (temporarily or more permanently) on the one or more storage devices 920 and/or may be received from an external source via one or more input interface units 930. The machine executable instructions may be stored as various software modules, each module performing one or more operations. Functional software modules are examples of components of the present description.

In some embodiments consistent with the present description, the processors 910 may be one or more microprocessors and/or ASICs. The bus 940 may include a system bus. The storage devices 920 may include system memory, such as read only memory (ROM) and/or random-access memory (RAM). The storage devices 920 may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present description may also be provided as a machine-readable medium for storing the machine-executable instructions. The machine-readable medium may be non-transitory and may include, but is not limited to, flash memory, optical disks, CD-ROMs, DVD ROMs, RAMs, EPROMs, EEPROMs, magnetic or optical cards or any other type of machine-readable media suitable for storing electronic instructions. For example, example embodiments consistent with the present description may be downloaded as a computer program which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium.

Example embodiments consistent with the present description (or components or modules thereof) might be implemented in hardware, such as one or more field programmable gate arrays (“FPGA”s), one or more integrated circuits such as ASICs, one or more network processors, etc. Alternatively, or in addition, embodiments consistent with the present description (or components or modules thereof) might be implemented as stored program instructions executed by a processor. Such hardware and/or software might be provided a server for example.

### § 4.4 Security Analysis of Example System

The attacks listed below are focused on the cryptographic techniques involved. This is not a fully exhaustive list, but highlights attacks on the integrity of the parties involved. These may be seen as attacks on the “root of trust” formed by the tri-party system of the creator, notary and registry.

### § 4.4.1 Attacks on Artifact Creation:

### § 4.4.1.1 Modification of the Artifact Pre-Notarization

Mitigation—non-issue as the artifact has to be produced and finalized before being notarized. If there is concern for modification beyond initial creation (e.g., in the event of a digital photo being captured), immediate or ‘as soon as possible’ delivery to notary ensures with reasonable confidence that an adversary would not have had the time to modify the original captured media. This might be important in a court of law to ensure the ‘Digital Chain of Custody’ this process represents was completed in the smallest possible reasonable period immediately after the artifact was captured.

### § 4.4.1.2 Post-Notarization Modification: Adversary Attempts Modification to the Artifact and Digital Fingerprint

Mitigation—While it is relatively straight-forward to calculate the fingerprint of the forged document, it would be nearly impossible to forge a digitally signed version using the creator's private key as long as the key is not compromised. Even if the private keys of the creator and notary are compromised, altering the immutable original record in the block-chain ledger would be close to impossible based on block-chain architecture.

### § 4.4.1.3 Attack: Exposure of the Candidate Artifact—E.G., Adversary Attempts to Access/Use the Artifact

Mitigation—Data confidentiality, if necessary, is provided as a separate optional service. It is incumbent on the creator to ensure artifact has a ‘physical’ chain of custody typically implemented via encryption techniques using the creator's private uncompromised key. The block-chain ledger artifact may not be modified even if it is accessed by the adversary.

### § 4.4.1.4 Attack: Adversary Accesses the Original Data Artifact, Modifies it, Appends Updated Meta Data, and Attempts to Create a New Notarized Version (Deep Fake)

Mitigation: This is the process of notarizing/copyrighting a new artifact and therefore not a concern. It is incumbent on the notary to multi-factor authenticate & authorize (Notary's IAM) the input from submitter as valid for the particular creator. This avoids an imposter from masquerading as a different authentic creator and subscriber of the notary service. The timestamping applied by the notary and at the registry steps will assure a temporal sequencing of multiple versions when reconciling the original artifact from the modified artifact. It is natural and not necessarily an adversarial attack to alter (improve, enhance, etc.) artifacts at a later date. It makes sense that the newer version would desire the same ‘bonded file’ conditions.

### § 4.4.2 Attacks on the Notary

### § 4.4.2.1 Attack: Adversary Attempts to Forge Notary Signature

Mitigation: the mathematical difficulty of deriving the private key of the notary based on the digital signature is proven sufficiently unlikely to act as proof that only the Notary can use their asymmetric key pair to sign candidate file information

### § 4.4.2.2 Attack: Adversary Attempts to Compromise the Notary'S it Infrastructure

Mitigation: it is expected that a competent Notary will be able to outsource, or in some reasonable manner, adequately secure and maintain a functioning PKI infrastructure

### § 4.4.2.3 Attack: Adversary Tries to ‘Replay’ the Signing Process for a Particular Candidate Artifact in Hopes to ‘Future Date’ it, Thereby, Invalidating the Temporal Sequence of Artifacts

Mitigation: Although it presents no significant benefit other than to update the strength of the cryptographic processes involved, there is no reason that an artifact could be signed multiple times. The original timestamping and ultimate registration will ensure that the order of events is maintained in perpetuity. Should the original process need to be reproduced to result in stronger cryptographic methods, the creator would be responsible for using the original bonded file as the ‘artifact’, append the appropriate meta data pursuant to ‘updating solely the cryptographic markers’, ask the Notary to sign as before, and register the event with the blockchain registry. The ‘re-encapsulated’ content would become the record that ensures the integrity of the content.

### § 4.4.2.4 Attack: Adversary Gains Access to Notary'S Private Keys Used to Sign Content

Mitigation: Registry will be checking the validity of a Notary's as a trusted business, but most importantly the Notary's Certificate Revocation List (CRL) to ensure that a bonded file was created, fingerprinted, and notarized using a certificate valid at the time of the registration event. Should a breach be discovered, the Notary will be held responsible to notify the affected creators and work with the creator to re-establish the notarization under a ‘breach event’. The registry will record and keep the ‘order of events’ and re-establish (maintain) the assurance of file integrity.

### § 4.4.3 Attacks on the Registry

### § 4.4.3.1 Attack: Adversary Attempts to Modify the Registry

Mitigation: the registry, as a consortium of parties, is based on a blockchain style ledger, where independent partners are maintaining ‘copies’ of the cryptographically chained record of events. An adversary would have to have control of all the ledger custodian's infrastructure in order to make coordinated updates. This action gets even more difficult when registrars are busy (registering many bonded files)

### § 4.4.4 Attacks on the Root of Trust

All attacks, such as those set forth in is this section could be qualified as attacks on the root of trust of the process. Adversary attaches on each member of the process (creator, notary, registry) are now discussed. “Mitigation” is a process designed to recover the responsibility of any of the three parties involved.

Creator: once registration is complete, it will be difficult for the creator to repudiate the file as their creation. The Notary and Registry will be enduring proof that the artifact was presented and recorded. This is the reason for the root of trust, but this may work against an adversary should they be trying to defame a creator or ‘deep fake’ the events the artifact intends to document.

Notary: if a Notary dissolves its business, or is compromised, it is the registry that supports the ‘re-establishment’ of the root of trust. The registry, as a third-party, has recorded (and even potentially stored original bonded file) the events and public keys used at the time of registration. The process is structured to allow the bonded file to be re-notarized as describe in the Notary attacks section

Registry: the multi-party nature of the blockchain ledger supports the integrity of the process that all parties must be subverted at the same time in order to corrupt the ledger. Should an act of collusion happen, the creator and Notary should maintain ‘receipts’ of the registration as method to dispute ledger discrepancies.

### § 4.5 Example Use Cases

Example use cases are provided in the following table. The invention is not intended to be limited to the use cases provided.

| AREA | USE CASES |
|---|---|
| Law | Video of events, i.e., from car or chest camera, can be DigiWitness ™ in |
| Enforcement | such a way that the chain of custody of such evidence starts the instant it is |
| | digitally witnessed. The video recording is irrefutably baselined upon |
| | creation and can be validated even if stored on public hosting environments |
| | (i.e., burden of ‘protecting’ the integrity of the file by typical restricted access |
| | methods is not necessary. Only confidentiality need be considered.) |
| Judicial | Any and all digital evidence will be in-tact, as DigiWitnessed ™, and when |
| | recorded in timely manner, serves as a ‘beyond a reasonable doubt’ that the |
| | evidence is not modified/tampered with. Additionally, digital evidence will |
| | not only be verifiably in-tact in the near term, but the evidence can be ‘re- |
| | witnessed’ to keep up with current cryptography methods, thus kept in-tact |
| | indefinitely. This is a necessity as legal battles may span multiple years and |
| | cryptography has a shorter life cycle. This verifiability serves in confirming |
| | accurate evidence disclosure i.e., data that prosecution and defence have is |
| | exactly the same. To include the ‘bundle’ of data disclosed includes all items. |
| Authenticated | The DigiWitness ™ process can be applied to physical and digital devices |
| IDs/ | that purport identity. ‘Cards’ such as SSN, Passports, Worker/officer badges, |
| Govt Issued IDs | even birth certificates can be compiled with ‘multiple authentication factors’ |
| | and digitally certified/witnessed by the issuer. End users can use the digital |
| | witness process to confirm these identity cards. E.g., banking representative |
| | can perform in-house services at the customers domicile, the customer can |
| | validate the corporate identification in a far more accurate way and avoid |
| | scams from a person pretending to be from the bank. |
| Digital | See Digital Minting appendix in the ′889 provisional, incorporated herein by |
| Minting | reference |
| Copyrighting | Digitized books and recordings of songs, podcasts/newscasts, can be |
| | DigiWitnessed ™ and made verifiable as original content (i.e., as-presented, |
| | as recorded). This will enable irrefutable proof of the content, whether it is |
| | being compared to other works for plagiarism, ‘which came first’, or |
| | validation of content included (or not included) in contested scenarios. |
| | Additionally, serves as a verifiable record for historical archiving. |
| Insurance | Insured parties file claims for damages and losses to their insured property. It |
| Claims | is in the best interest of the insurers to make sure the extent of the damage be |
| | irrefutably recorded as temporally close as possible to the reported event to |
| | prevent insurance fraud. Insurance surveyors and loss assessors can |
| | DigiWitness ™ the photographs, video recordings and the statements of the |
| | insured to ensure integrity with the reimbursement claimed at a later time for |
| | their evidence to be validated in the court of law. |
| Healthcare | Health records are considered sacrosanct based on privacy laws and HIPAA |
| Records | regulations. Most of the healthcare providers have switched to digital systems |
| | whereby patient records are saved to the cloud or to an intermediate storage |
| | system during or right after the patient appointment. These records are also |
| | used for eventually billing the health insurance provider. Tampering with |
| | these records could be done for various nefarious purposes and it's in the best |
| | interest of the insurance companies to DigiWitness ™ medical examination |
| | records which may include various health metrics and physician's comments. |
| | Such records may then be compared if there is a reason to believe that the |
| | records presented for insurance reimbursement were tampered with or even |
| | as a SOP to detect record integrity violations. |
| Journalism | Spreading fake or doctored artifacts on social media or sometimes |
| Validation | mainstream outlets is done for various purposes. These days newsworthy |
| | events are quickly captured by ordinary citizens at the scene of the incident |
| | with a smart phone camera posing as freelance journalists. News media |
| | outlets may offer monetary compensation to freelancers who may have |
| | captured the best footage. When this happens national or local news media |
| | may expose themselves to serious liability by broadcasting doctored or fake |
| | content. By only accepting DigiWitnessed ™ footage from freelancers OR |
| | DigiWitnessing ™ their own or purchased content recorded as close to the |
| | incident occurrence as possible can dramatically reduce the liability and/or |
| | reputational damage to media outlets. |
| Real Estate/ | Contracts of any/all types will be DigiWitness ™ and made verifiable for |
| Contracts | business-as-usual & contested scenarios. When coupled with state-of-the-art |
| | authentication services, acts as a truly durable, irrefutable record of the |
| | agreement. |
| Digital | There is ever pressing need to have irrefutable and secure way of recording |
| Universes | all transaction. DigiWitnessing ™ these digital transactions (just like any |
| (Metaverse) | physical world transactions) will be the need of the hour. |
| | Metaverse will be inflicted with the same Cyber Security vulnerabilities as |
| | any physical assets including “thefts” of digital assets. Like any other digital |
| | artifact, these Digital assets will need to be protected, backed-up and will |
| | need proof of ownership. |

### § 4.6 Example User Interfaces and Data Structures

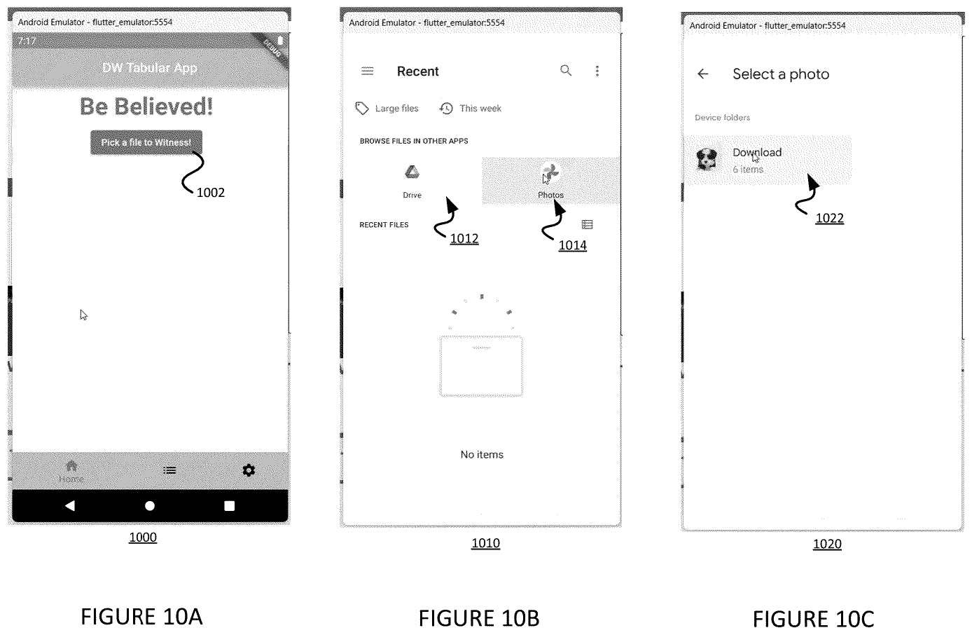

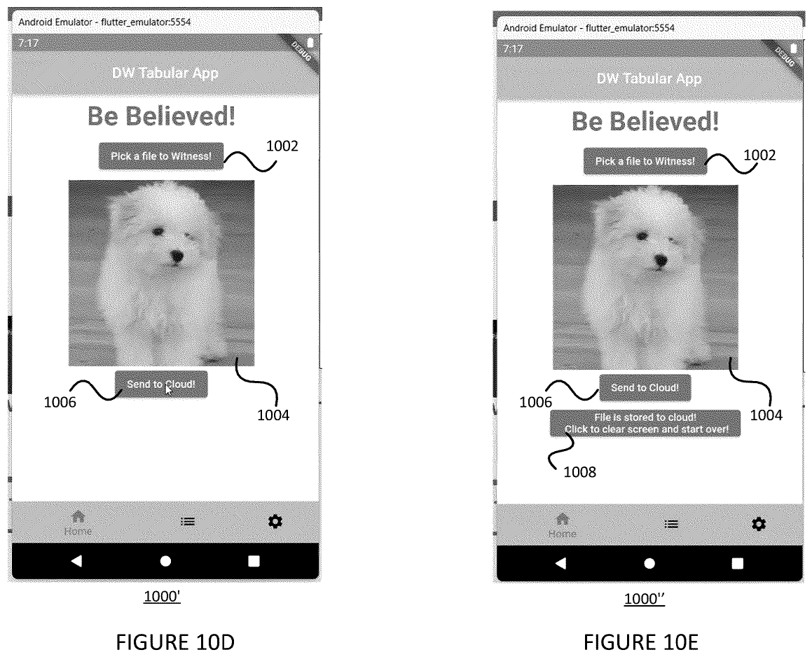

FIGS. 10A-10E are example user interface screens for navigating to an image, selecting an image by the creator for fingerprinting, storing the selected image with a digital fingerprint, and requesting a notary to digitally sign the image in an example mobile application. Referring to FIG. 10A, user interface screen 1000 includes a selectable button 1002 to allow a user to initiate a process for selecting an image (or some other digital work product) to be fingerprinted. Referring to FIG. 10B, user interface screen 1010 has selection areas 1012 and 1014 to allow a user to select a remotely stored and locally-stored images, respectively. FIG. 10C illustrates a user interface screen 1020 with a selection area 1022 for selecting a locally stored image to be fingerprinted.

Referring next to FIG. 10D, user interface screen 1000′ illustrates the selected image 1004 and a selectable button 1006 for allowing the user to store the image and a fingerprint (e.g., hash) thereof on the cloud. Finally, FIG. 10E illustrates a user interface screen 1000″ including an acknowledgement message 1008 after the image and its fingerprint have been stored.

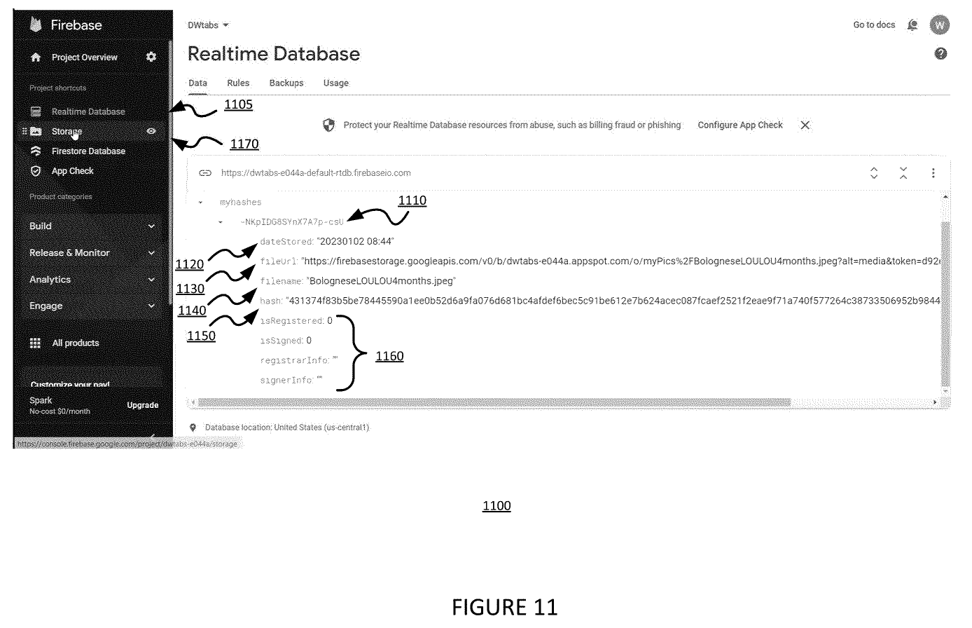

FIG. 11 illustrates example database record information 1100 about the image selected, fingerprinted, and stored (but not yet notarized) in the example of FIGS. 10A-10E. As shown, this information 1100 includes an identifier 1110, a time and date stamp of the storage 1120, a location at which the file (and its fingerprint) are stored 1130, a file name 1140, and a hash 1150. Information fields 1160 not yet populated include information related to signing and registration of the file. This information screen 1100 is provided when the selectable “Realtime Database” element 1105 in the left column is selected. The image itself can be accessed via the selectable “Storage” element 1170 in the left column.

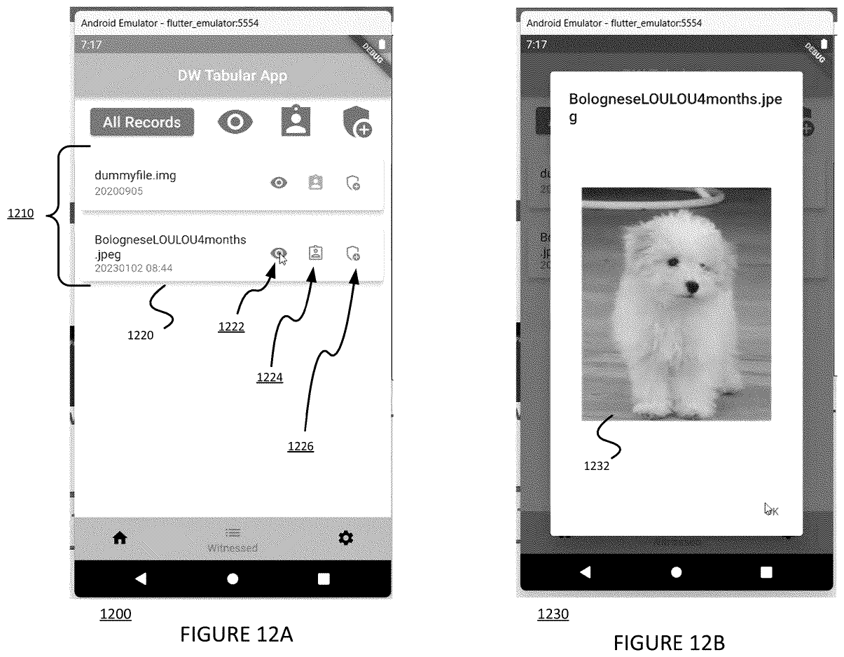

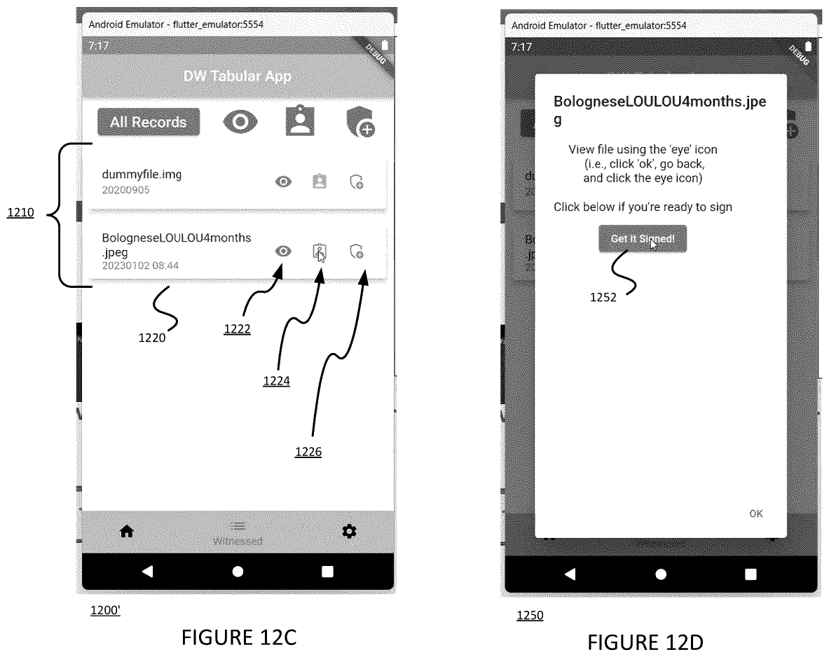

FIGS. 12A and 12B are example user interface screens illustrating multiple records (e.g., corresponding to multiple images) 1210, as well as icons for showing the status of a given image. More specifically, in FIG. 12A, screen 1200 includes a portion displaying records 1210. One of the records 1220 includes, in association with a file name, a first icon 1222, a second icon 1224, and a third icon 1226. Each of the icons 1222, 1224 and 1226 is depicted in monotone (e.g., black and white, or greyscale) until a corresponding action is initiated and/or completed. For example, in the user interface screen 1200 of FIG. 12A, the colored first icon 1222 indicates that the image and its fingerprint have been stored. Referring to FIGS. 12A and 12B, if the user selects this first icon 1222, a user interface screen 1230 including the stored (and fingerprinted) image 1232 is displayed.

FIGS. 12C and 12D are example user interface screens for requesting the image to be “signed” by a digital notary, in an example mobile application. Referring to FIG. 12C, the user (not shown) selects the second icon 1224 on the user interface screen 1200′. Referring to FIG. 12D, in response, the user is presented with a user interface screen 1250 including a selectable area 1252 to allow the user to initiate a digital notary signing process. When the user selects this selectable area 1252, the fingerprinted image is provided to a digital notary for signature. (Recall, e.g., 270 of FIG. 2B.)

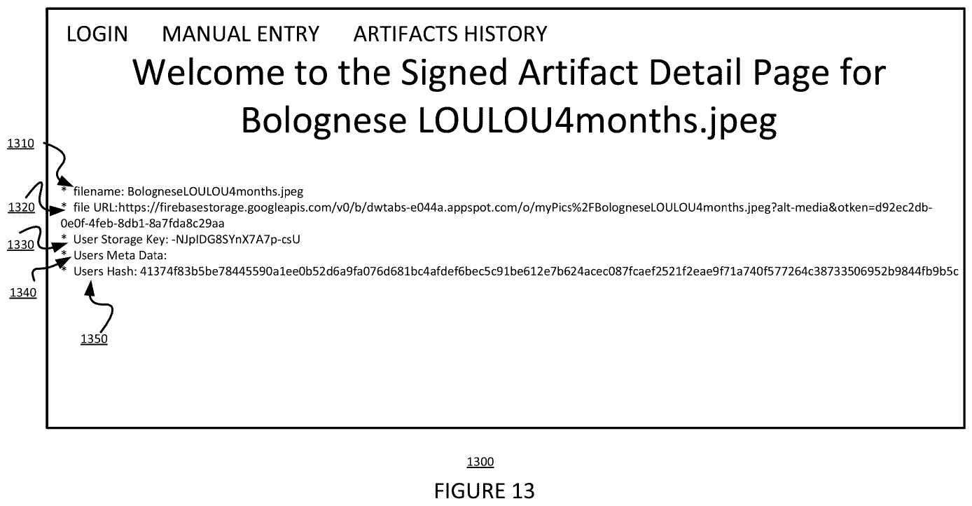

FIG. 13 illustrates database record information 1300 about the selected image that has been stored and signed by a digital notary. This screen is available to a digital notary who has logged in. As shown, this information 1300 includes a file name 1310, a file location 1320, a user storage key 1330, meta data 1340 (if any) and a hash value 1350 associated with the user. This recorded information 1300 may be considered to be a “bonded file.” (Recall, e.g., 230 of FIG. 2A.)

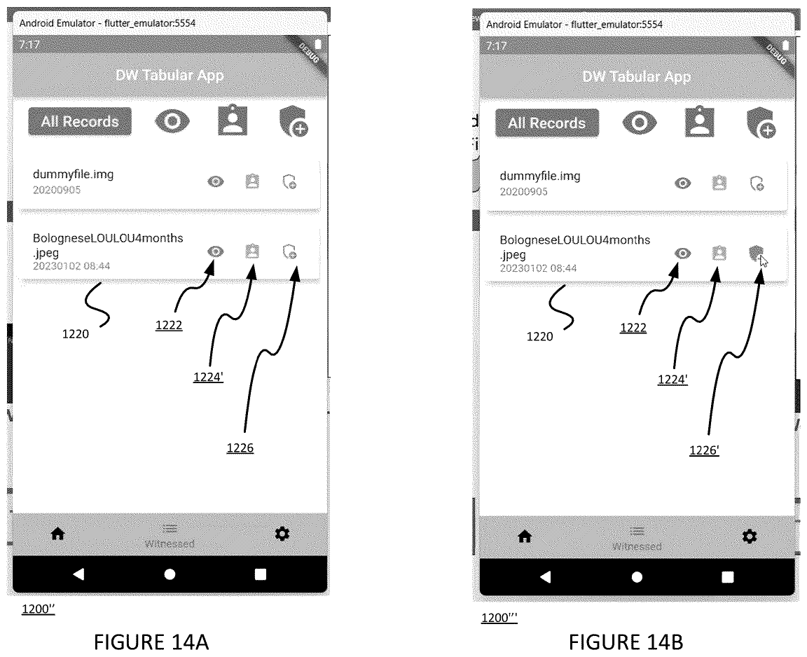

FIGS. 14A and 14B are example user interface screens illustrating icons for showing the updated, current status of the given image (or other digital workproduct), and for requesting that the signed image be stored with a registrar, such as in an irrefutable ledger. Referring to the interface screen 1200″ in FIG. 14A, since the image has been stored and digitally signed by a digital notary, both the first icon 1222 and the second icon 1224′ of record 1220 are depicted in color. Assume that the user (not shown) then selects the third icon 1226. Responsive to this selection, the file is registered (e.g., stored on an irrefutable ledger) with a registrar. Once this registration is complete, as shown in the user interface screen 1200″′ of FIG. 14B, the third icon 1226′ is displayed in color.

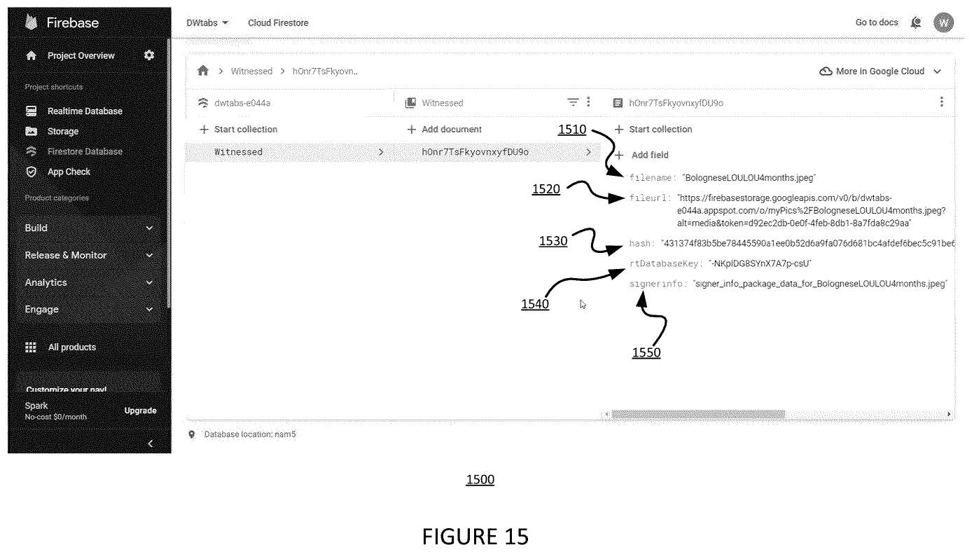

FIG. 15 illustrates database record information 1500 about the selected, signed, and registered image. As shown, this information 1500 may include one or more of a file name 1510, a file location 1520, the user hash used 1530, a database key 1540, and information about the digital notary who digitally signed the image 1550.

As the above sequence indicates, a user can quickly and intuitively register a digital work for purposes of later validation. Since the notary and registrar data are from trustful sources, it can be ensured that the image has integrity.

### § 4.7 Refinements, Alternatives, and/or Extension

Our invention is not limited to the specifics of the examples provided. For example, a Digital Artifact can be uploaded from a mobile device or any other device that can connect to Internet. As another example, although SHA512 encryption was described, other types of encryption can be used instead.

Other example implementations and features are described in §§ 4.7.1-4.7.3 below.

### § 4.7.1 Zero Knowledge Implementation

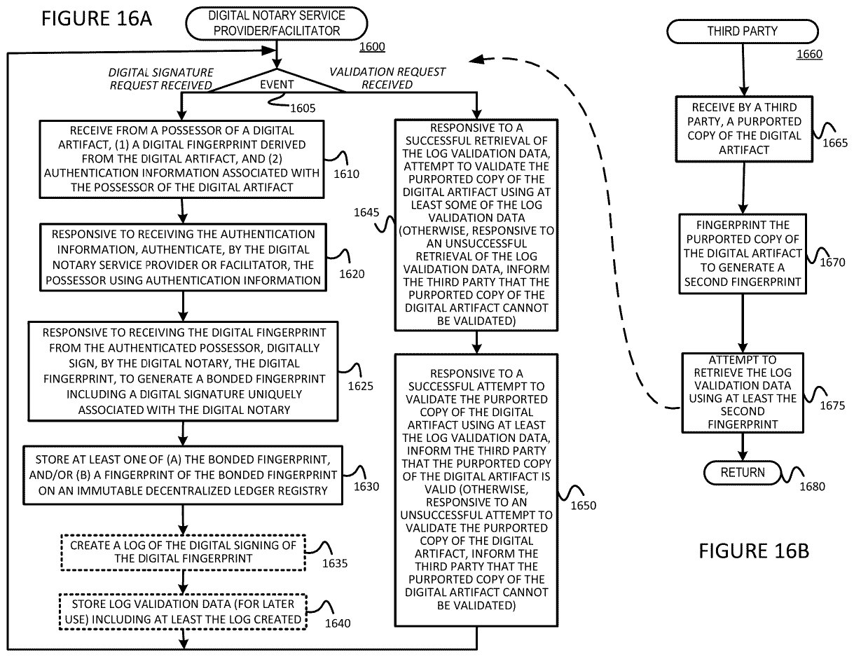

FIGS. 16A and 16B are flow diagrams of an example “zero knowledge” implementation of methods consistent with the present description. Assume first that a third party “possessor” of a digital artifact creates a digital fingerprint (e.g., hash) from the digital artifact (e.g., using a local application of a digital notary service provider/facilitator, or a website of the digital notary service provider/facilitator, etc., such that the possessor need not provide the digital artifact to another party in order to create the digital fingerprint). The digital notary service provider/facilitator either (A) provides a digital notary service and acts as a digital notary, or (B) facilitates a digital notary service through an independent third party acting as the digital notary.

Referring first to FIG. 16A, different branches of the example method 1600 are performed in response to the occurrence of different events. (Even branch point 1605) The left branch of the example method 1600 is performed responsive to receiving a digital signature request from the possessor. This request received by the digital notary service provider/facilitator includes (1) authentication information associated with the possessor of the digital artifact, and (2) the digital fingerprint. (Block 1610) Note that the digital notary service provider/facilitator is not (or at least need not be) provided with the digital artifact. Responsive to receiving the authentication information, the digital notary service provider/facilitator authenticates the possessor using authentication information. (Block 1620) Responsive to receiving the digital fingerprint from the authenticated possessor, the digital notary digitally signs the digital fingerprint, to generate a bonded fingerprint including a digital signature uniquely associated with the digital notary. (Block 1625) Finally, the example method 1600 stores at least one of (A) the bonded fingerprint, and/or (B) a fingerprint (e.g., hash) of the bonded fingerprint (e.g., for more efficient storage), on an immutable decentralized ledger registry (e.g., a blockchain). (Block 1630) The immutable decentralized ledger registration may assign a date and time stamp tied to the time of storage.

Referring back to block 1625, as noted above, the digital notary service provider/facilitator will either: (A) act as the digital notary itself (and therefore might not need another authentication of the service provider/facilitatory to the digital notary, since it is the digital notary); (B) will use a third party digital notary that it does need to authenticate to in order to have the digital fingerprint from the possessor signed by the digital notary; or (C) will use a free third party digital notary service (in which case, authentication might be optional). In scenarios in which an external third party digital notary is used, authentication might not be relevant. In such scenarios, block 1625 of the example method 1600 may be modified as follows. Responsive to receiving the digital fingerprint (and possibly the digital artifact itself) from the authenticated possessor, the digital notary service provider/facilitator may recreate the digital fingerprint of the artifact (if the artifact itself if provided) and validate it against the digital fingerprint provided by the possessor. If the fingerprints match, the digital fingerprint will be considered valid. (Note, however, that this would not be a “zero knowledge” implementation.) If the possessor does not provide the artifact to the digital signature service provider/facilitator, the digital signature service provider/facilitator will assume correctness because the digital signature service provider/facilitator has zero knowledge of the artifact itself. The digital fingerprint will then either (A) be signed by the digital signature service provider/facilitator acting as a digital notary provider, or (B) be sent by the digital notary service provider/facilitator (acting as a facilitator) to an external notary for their digital signature. In either case, the example method 1600 creates a bonded fingerprint. Note that in scenarios in which the artifact is provided in the request (which would not be a “zero knowledge” implementation), the digital notary service provider or facilitator may discard the digital artifact. Alternatively, the digital notary service provider or facilitator may store the digital artifact as validation data (e.g., as part of a validation data set) to be used later.

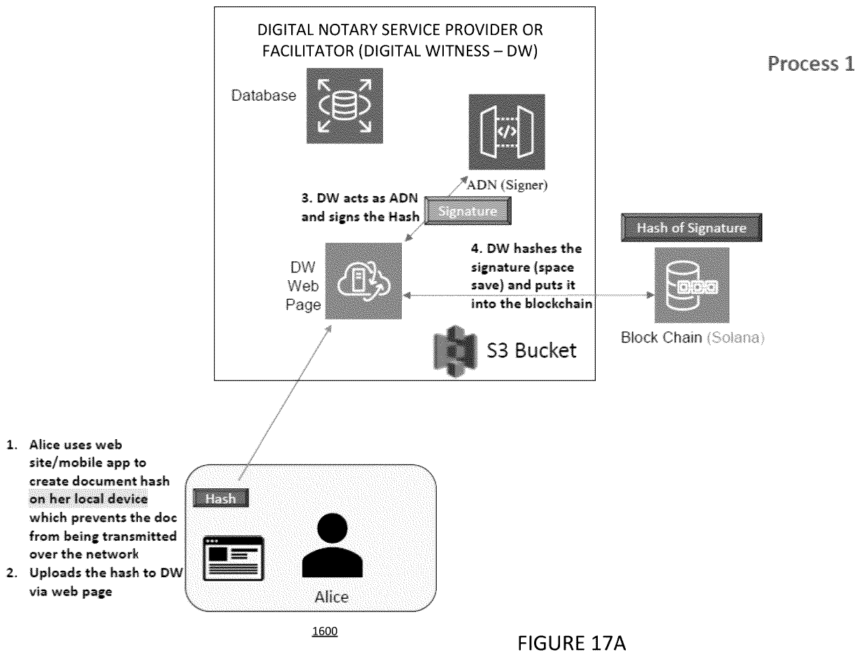

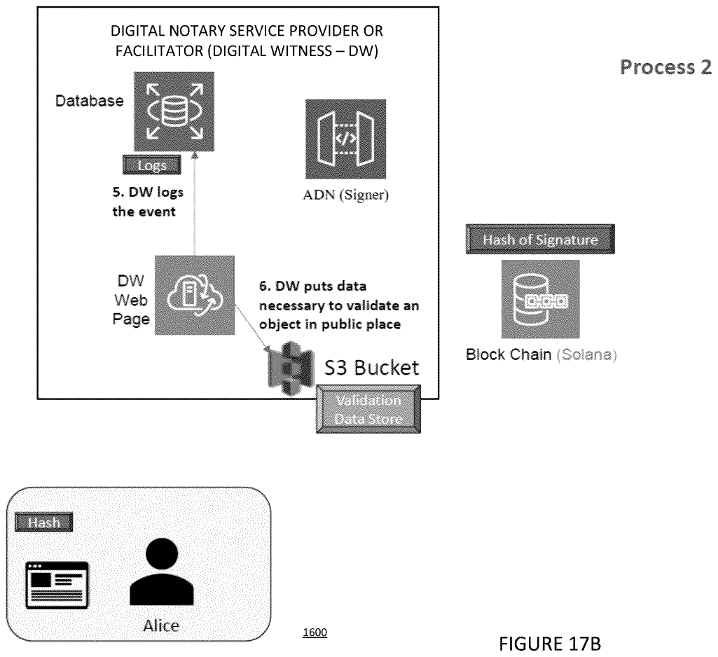

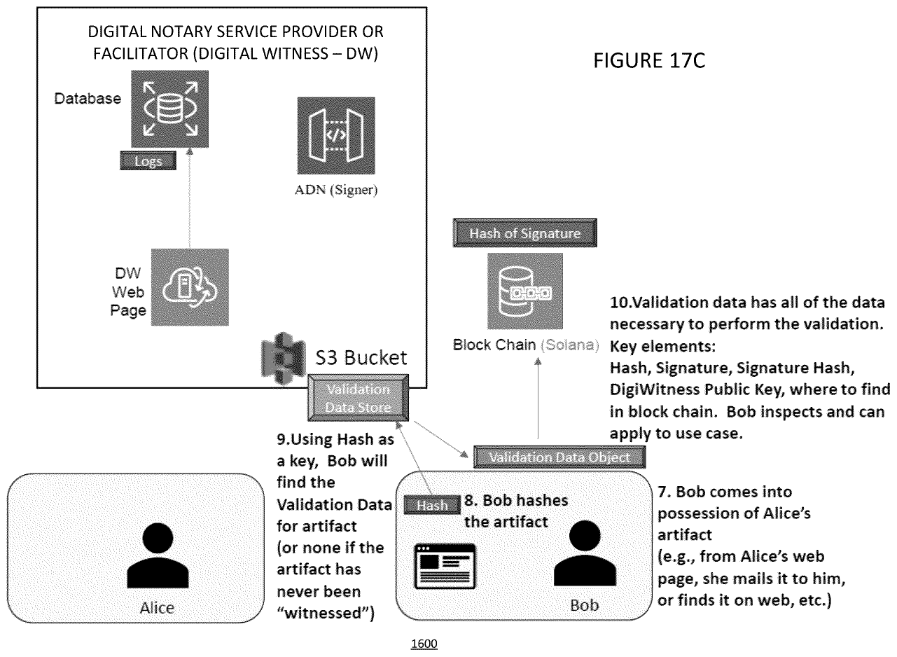

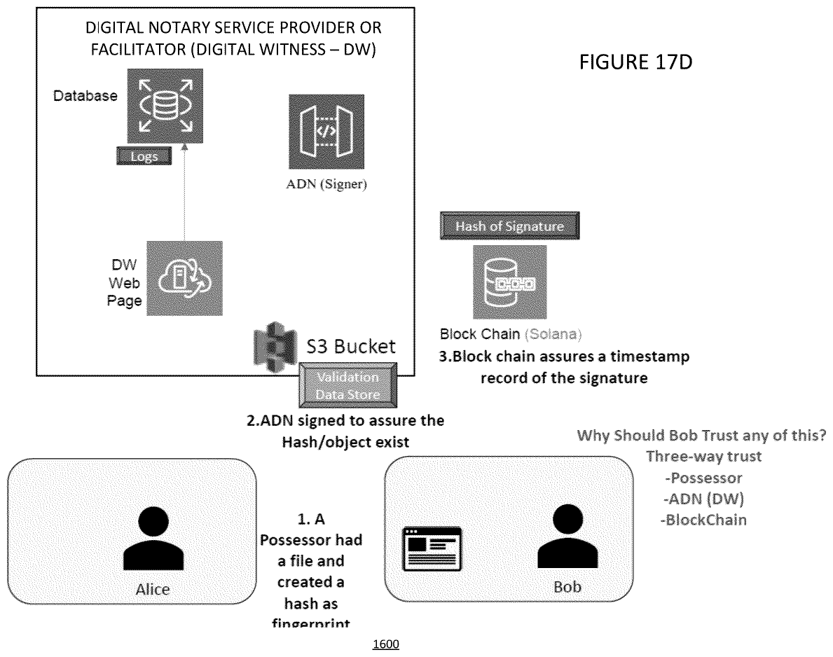

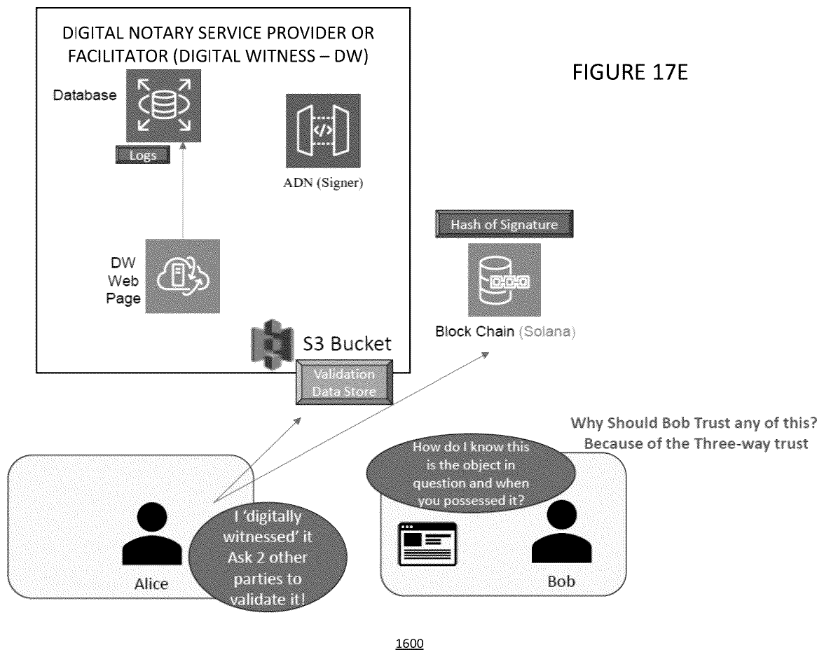

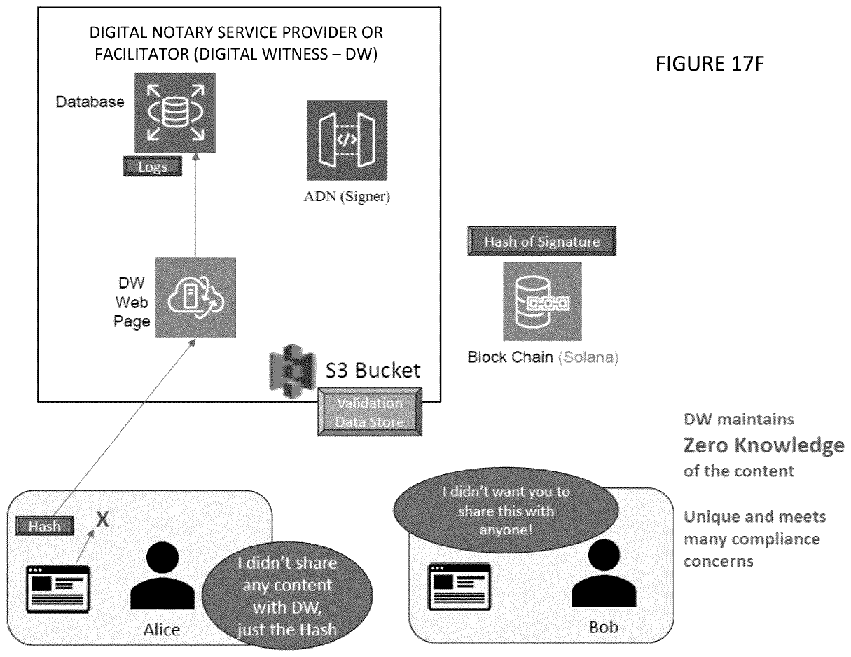

FIG. 17A illustrates example operations of the above method steps. As shown, (1) Alice uses web site/mobile app of the digital notary service provider/facilitator to create a hash of a digital artifact on her local device which prevents the digital artifact from being transmitted over the network, and (2) uploads the hash to a digital notary service provider or facilitator (DW) via a web page. In this example, DW (3) acts as an automated digital notary (ADN) and signs the Hash, and then (4) hashes the signature (to save space) and puts it into the blockchain.

Still referring to the left branch of the example method 1600, the example method 1600 may also create (e.g., by the digital notary, or a local agent application of the digital notary, or the digital notary service provider/facilitator, or a local agent application of the digital notary service provider/facilitator), a log of the digital signing of the digital fingerprint (e.g., by the digital notary, or a local agent application of the digital notary, or the service provider, or a local agent application of the service provider). (Block 1635) Log validation data including at least the log created (to be used in validating the log) is then stored. (Block 1640)

FIG. 17B illustrates example operations of these additional method steps. In this example, DW (5) logs the event, and (6) puts data to be used to validate an object in a shareable (e.g., public) place.

Note that the log validation data may further include one or more of (1) the digital fingerprint of the digital artifact, (2) the bonded fingerprint, (3) the fingerprint of the bonded fingerprint, (4) a public key associated with the digital notary and the digital signing process used by the digital notary, and/or (5) a lookup information for retrieving the at least one of (A) the bonded fingerprint, and/or (B) a fingerprint of the bonded fingerprint from the immutable decentralized ledger registry. As already noted above, the log validation data may also include the digital artifact.

This set of log validation data (referred to as a “Validation Data Set”) may be completed by one, all, or a subset of the parties involved, and might not all be stored in the same place. The data components themselves, (e.g., actual digital fingerprint data, the actual bonded fingerprint data, etc.) or at minimum a reference to where these data components can be viewed may be used later for validation. Thus, in some implementations, the log validation data is indexed, at least in part, by the digital fingerprint of the digital artifact (and perhaps a time/date stamp of the signing). Referring to the example of FIG. 17B, the JSON formatted validation data in the S3 bucket in the bottom right (not the log in the internal database) is indexed by the artifact fingerprint (hash of the original document; not the bonded fingerprint, and not the fingerprint of the bonded fingerprint). However, this index might not be the complete/full name of the JSON file (i.e., the validation data). That is, the artifact fingerprint might be a partial key which, when concatenated with a date/time field, creates the JSON filename. One advantage of adding a date/time to the JSON file name, is that many people may witness the same exact artifact for their own purposes, and the date/time of that witness makes the JSON filename unique and storable in the S3 bucket. This S3 bucket is intended to give the full validation data in JSON format, thus computer usable. However, the “public” aspect of the S3 bucket itself is in question. For example, if a dedicated instance of the digital notary service provider/facilitator application is made for a given company X, company X might not want the validation data to be public. In these scenarios, in the S3 bucket, the JSON content area would only available to (e.g., shareable with) authorized users (which could be authorized to anyone). That is, some of the JSON files themselves might be restricted to (or shareable with) a few authorized users.

Assume now that a third party wishes to validate that a purported copy of the digital artifact is valid. Referring to FIG. 16B, in the example method 1660, a third party receives a purported copy of the digital artifact. (Block 1665) The purported copy of the digital artifact is then fingerprinted (e.g., using the same hash procedure) to generate a second fingerprint. (Block 1670) The example method 1660 then attempts to retrieve the log validation data using at least the second fingerprint (e.g., by submitting a validation request). (Block 1675)

Referring next to the right branch of example method 1600, responsive to a successful retrieval of the log validation data, the example method 1600 attempts to validate the purported copy of the digital artifact using at least some of the log validation data, and otherwise, responsive to an unsuccessful retrieval of the log validation data, the example method 1600 may inform the third party that the purported copy of the digital artifact cannot be validated. (Block 1645) Next, responsive to a successful attempt to validate the purported copy of the digital artifact using at least the log validation data, the example method 1600 may inform the third party that the purported copy of the digital artifact is valid (whereby the third party has at least three-way trust from (1) the party providing the purported copy of the digital artifact, (2) the digital notary, and (3) the immutable decentralized ledger registry), and otherwise, responsive to an unsuccessful attempt to validate the purported copy of the digital artifact, the example method 1600 may inform the third party that the purported copy of the digital artifact cannot be validated. (Block 1650) Although not shown, the example method 1660 may provide the responses to the third party, before the example method is left. (Return node 1680)

Referring back to blocks 1675 and 1645, the log validation data may be referred to as the “validation data” or “validation data set.” Thus, at least the second fingerprint is used to attempt to retrieve the validation data set. Responsive to a successful retrieval of the necessary validation data set components, validation of the purported copy of the digital artifact is attempted using at least some of the validation data set.

Although the example method 1600 informs the third party of an unsuccessful validation request, following an unsuccessful retrieval of the validation data set, the third party may simply infer that purported copy of the digital artifact has not been processed and cannot be validated (if it is also assumed the third party has not committed errors in their retrieval).

Note that the although the validation data set may include some log data, log data may also include certain data that is not included in the validation data set, or certain data that is stored elsewhere for other purposes. For example, some log data may go into a private database used for other functions like billing, keep track of the number of records that the user has used, etc., while the validation data set goes into an area for use by third parties that want to perform validation. Although the validation data storage could be made public, it might not be. For example, it could be restricted to (e.g., shareable with) any subset of interested parties (e.g., just courts of law, just a company's internal organizational branches, etc.).

Example operations of these steps are illustrated in FIG. 17C. in this example, Bob (or any of a million persons) wants to know if the object they have has been witnessed. The data stamp, etc., is applied per use case, when the digital witnessing of the artifact by a digital notary is complete. And the implications of the digital notarization will depend on the use case. Note also that the third party could be the party that had the digital artifact signed. That is, in this example, the third party could be Alice, the original possessor of the digital artifact. Or the third party could be someone who has received or created an identical artifact (e.g., Bob), or Carol, Dave, Eve or any one of the millions of entities out there who may wish to validate the authenticity of the artifact they have access to either through private or public means. Referring to FIG. 17C, in this example, Bob (7) comes into possession of Alice's artifact (e.g., from Alice's web page, she mails it to him, or finds it on web, etc.), (8) hashes the artifact, and (9) will find the validation data for artifact using the hash as a key (or will find none if the artifact has not been “witnessed” as alleged). The validation data (10) has all of the data necessary to perform the validation (e.g., Hash, Signature, Signature Hash, DW Public Key, where to find in block chain). Bob inspects and can apply to use case.

Referring to FIGS. 17D and 17E, three-way trust is provided because (1) the possessor (Alice) had a file and created a hash as fingerprint, (2) the DW (acting as an ADN) signed to assure the Hash and/or object exist, and (3) the blockchain assures a timestamp record of the signature. FIG. 17F illustrates the “zero knowledge” aspect of the implementation in which the possessor provides only a fingerprint (e.g., hash) of the artifact to be signed, but not the artifact itself.

Referring back to block 1630, in one example implementation, the fingerprint of the bonded fingerprint is stored in the immutable ledger (blockchain) for purposes of data compression. It would be useful to store the bonded fingerprint instead, but its size makes it less affordable.

Storing this information on the blockchain provides an immutable timestamp of the digital notarization (i.e., witnessing) of the digital artifact or of the fingerprint (e.g., hash) of the digital artifact.

Again referring to FIGS. 17C-17F, along with the JSON file, Bob will be able to agree that the hash of the bonded fingerprint is definitely timestamped (because it is on the blockchain), Bob can then proceed to the JSON file to see the digital notary signature (that is, the bonded fingerprint) and validate it by hashing the bonded digital fingerprint and confirming that it matches what was stored on the blockchain. If they match, Bob can then validate the bonded fingerprint against the digital fingerprint by pulling the public key that was used by the digital notary to create the bonded fingerprint. If all matches, Bob can assume that the digital artifact that he possesses is identical to the original artifact. Recall that Bob used that fingerprint of the purported copy of the digital artifact as (at least a partial) key lookup to even find the JSON file.

Note that in the example of operations illustrated in FIGS. 17A-17F, as will be apparent from the context, a “third party” might be a party independent of the digital notary service provider or facilitator (DW) and/or might be a party independent of the possessor of the digital artifact that had the digital artifact (or a fingerprint (e.g., hash) thereof) digitally notarized/signed/witnessed).

### § 4.7.2 Receipting for Enhanced Authentication

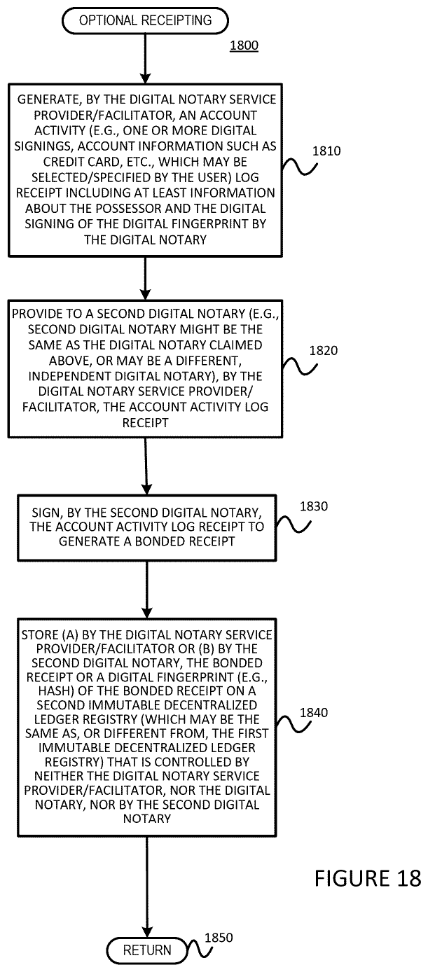

FIG. 18 is a flow diagram of an example “receipting” extension to example methods consistent with the present description. By also “witnessing” the possessor's activity, the possessor can better present the witnessed logs of their activity as evidence of that the possessor had the digital artifact digitally notarized (e.g., witnessed). This is referred to as a “receipt.” Having a receipt is useful because there is no foolproof way to truly identify someone electronically. (This is commonly referred to as “Flaw in Identity.”) That is, there is not a foolproof and world-wide trusted multi-factor authentication. As will be appreciated from the following, digitally witnessing logs of the possessor's activity will act as a “receipt” and will help provide definitive evidence of account activity that could be reconciled against other evidence (e.g., payment system logs) to build trust that Alice is truly the person that, at a particular time and using a particular account, had a digital artifact (or artifacts) digitally notarized (i.e., witnessed).

Referring the flow diagram of FIG. 18, the example method 1800 generates (e.g., by the digital notary service provider or facilitator) an account activity (e.g., one or more digital signings, account information such as credit card, etc., which may be selected/specified by the user) log receipt including at least information about the possessor and the digital signing of the digital fingerprint by the digital notary. (Block 1810) The account activity log receipt is then provided to a second digital notary (e.g., second digital notary might be the same as the digital notary claimed above, or may be a different, independent third party digital notary), by the digital notary service provider or facilitator. (Block 1820) The second digital notary then digitally signs the account activity log receipt to generate a bonded receipt. (Block 1830) Finally, the bonded receipt or a digital fingerprint (e.g., hash) of the bonded receipt is stored (e.g., by (A) the digital notary service provider or facilitator or (B) the second digital notary) on a second immutable decentralized ledger registry (which may be the same as, or different from, the first immutable decentralized ledger registry). (Block 1840) Preferably, the second immutable decentralized ledger registry is controlled by neither the digital notary service provider or facilitator, nor the digital notary, nor by the second digital notary. The example method 1800 is then left. (Return Node 1850)

Referring back to block 1810, in some example implementations, the account activity included in the log receipt may be one or more of an action and/or event within a fourth party system (e.g., send email to email system not owned by the account owner, or generate a charge to the account owner's payment system, etc.) to instance a coincidental event (e.g., which provides temporal corroboration evidence, multifactor attribution evidence, and/or concurrence evidence) with the receipting process. That is, a purpose of these coincidental events in independent systems is to assist the possessor in evidencing that they are the same entity behind these events, thus authenticating the possessor in a substantial way. By reconciling the actions between both independent systems at the same time by the same possessor, the possessor has a significant claim of authenticity as the possessor that witnessed the artifacts as detailed in the receipt.

Validation using the receipting extension is similar to that described above. That is, assume that a third party receives a purported copy of the digital artifact. (Recall block 1665.) The purported copy of the digital artifact is fingerprinted (e.g., hashed) to generate a second fingerprint. (Recall block 1670.) The third party can then attempt to retrieve the log validation data using at least the second fingerprint. (Recall, e.g., block 1675.) Responsive to a successful retrieval of the log validation data, the bonded receipt enhances security as follows. Rather than just using the log validation data, it is attempted to validate the purported copy of the digital artifact using both (1) the log validation data and (2) the bonded receipt. Responsive to an unsuccessful retrieval of the log validation data, the third party may be informed that the purported copy of the digital artifact cannot be validated. (Recall block 1645.) Responsive to a successful attempt to validate the purported copy of the digital artifact using at least the log validation data and the bonded receipt, the third party may be informed that the purported copy of the digital artifact is valid. (Recall block 1650.) In this way, the third party has at least four-way trust from (1) the party providing the purported copy of the digital artifact, (2) the digital notary (3) the second digital notary, and (4) the immutable decentralized ledger registry/registries (whereby the coincidental actions of the first and second digital notaries evidence that the same person/actioner is/was in control of both systems at the time of receipt). Otherwise, responsive to an unsuccessful attempt to validate the purported copy of the digital artifact, the third party may be informed that the purported copy of the digital artifact cannot be validated. Alternatively, responsive to an unsuccessful retrieval of the validation data set, the third party may infer that purported copy of the digital artifact has not been processed and cannot be validated (if they also assume the third party has not committed errors in their retrieval).

As should be appreciated from the foregoing, in implementations in which there is a “lack of coincidence” between the digital notary and the second digital notary, there is additional evidence that the possessor (user) (e.g., Ann) is the account holder/actioner in both systems. This additional evidence is useful if the possessor wants to strengthen their claim as a possessor (which may or may not be deduced as creator of the digital artifact).

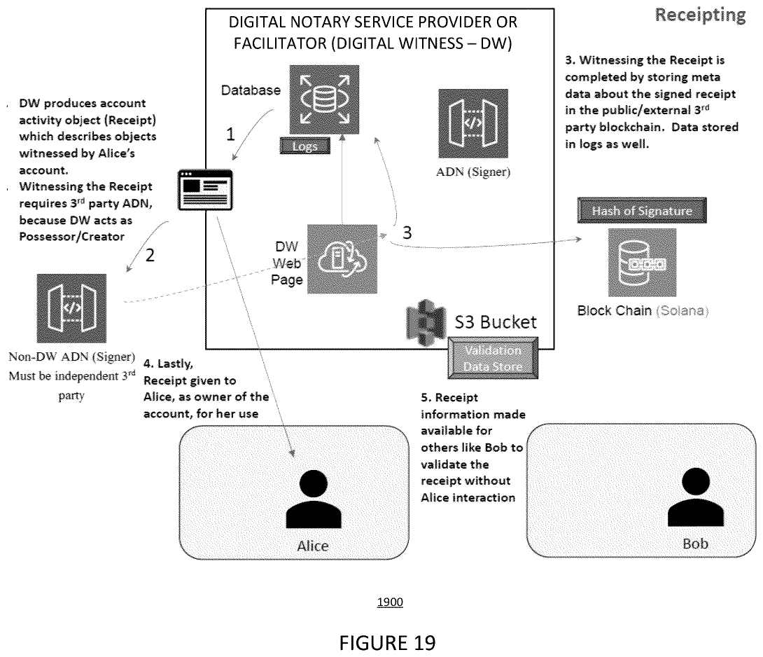

FIG. 19 illustrates operations in an example “receipting” extension to example methods consistent with the present description. As noted above, this is important as there is no way to truly identify someone electronically. (Flaw in Identity) Here, the witnessed (digitally notarized) logs act as a “receipt” and help provide definitive evidence of account activity that could be reconciled against other evidence (e.g., payment system logs) to build trust that Alice is truly the person that witnessed objects through that account, and at a particular time. This is a valid use case for general receipts, that Alice can have a typical receipt witnessed and given to Bob. Bob can later present the witnessed receipt (e.g., for warranty validation). Alice would accept the witnessed receipt.

More specifically, in this example, (1) DW produces account activity object (receipt) which describes objects witnessed by Alice's account, and (2) witnessing the receipt uses an independent, third party ADN (automated digital notary). In this example, DW acts as possessor/creator of the log/account activity. Witnessing the receipt is completed by (3) storing meta data about the signed receipt in the public/external third party blockchain. Data is stored in logs as well. Next, (4) the receipt given to Alice (e.g., directly from the third party ADN, or indirectly via DW), as owner of the account, for her use. That is, Alice can (5) make the receipt information available for others like Bob to validate the receipt without Alice's interaction.

Note that in the example of operations illustrated in FIG. 19, as will be apparent from the context, a “third party” might be a party independent of the digital notary service provider or facilitator (DW) and/or might be a party independent of the possessor of the digital artifact that had the digital artifact (or a fingerprint (e.g., hash) thereof) digitally notarized/signed/witnessed).

### § 4.7.3 Using Breadcrumb for Enhanced Authentication

In some example implementations consistent with the present description, the authentication information associated with the possessor of the digital artifact includes an identity breadcrumb that allows a third party identification provider (e.g., an IDP such as, for example, IDme) to later validate an identity of the possessor. In such example implementations, the digital notary (e.g., the digital notary service provider/facilitator) digitally signs the identity breadcrumb, to generate a bonded identity breadcrumb. When at least one of (A) the bonded fingerprint, and/or (B) a fingerprint (e.g., hash) of the bonded fingerprint (e.g., for more efficient storage) is stored on an immutable decentralized ledger registry, at least one of (A) the bonded identity breadcrumb, and/or (B) a fingerprint of the bonded identity breadcrumb, is also stored in association (e.g., concatenated) with the at least one of (A) the bonded fingerprint, and/or (B) a fingerprint of the bonded fingerprint, on the immutable decentralized ledger registry.

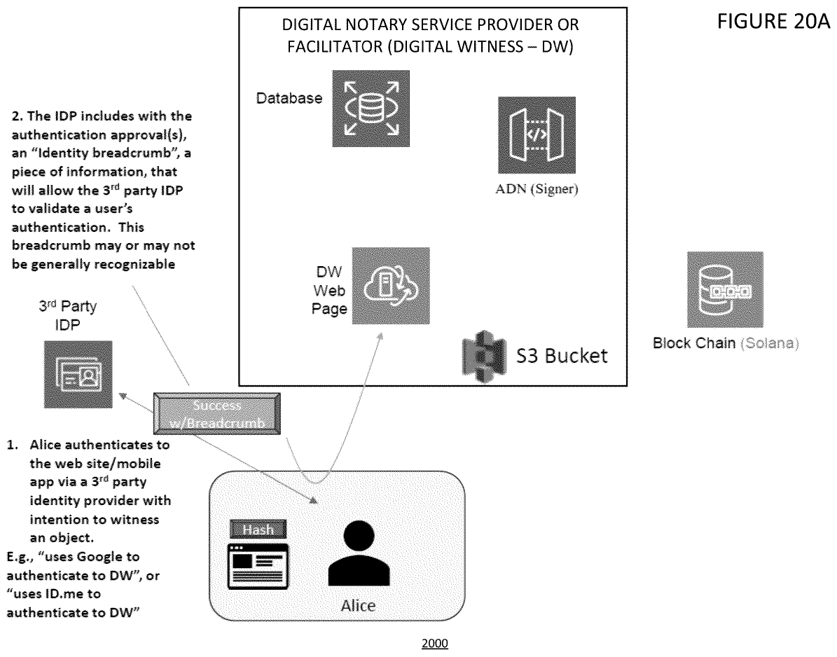

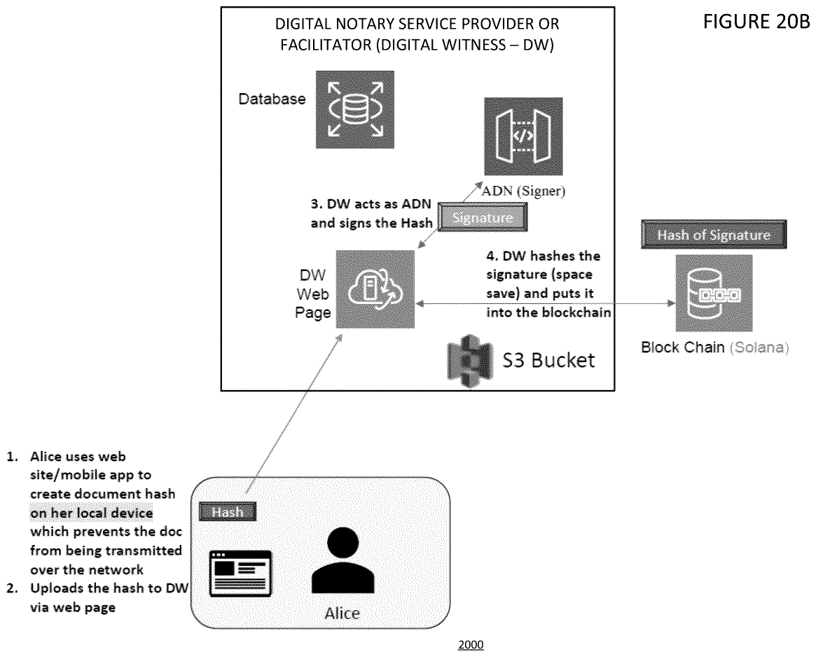

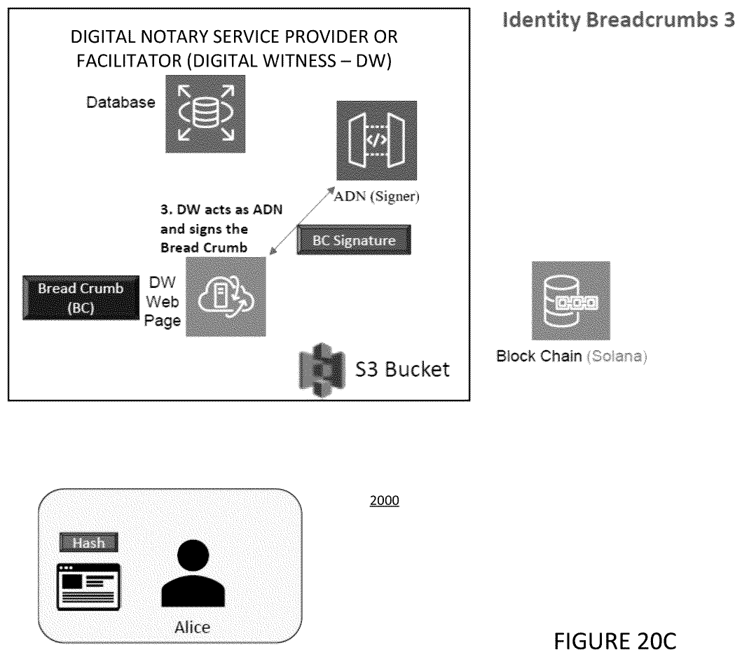

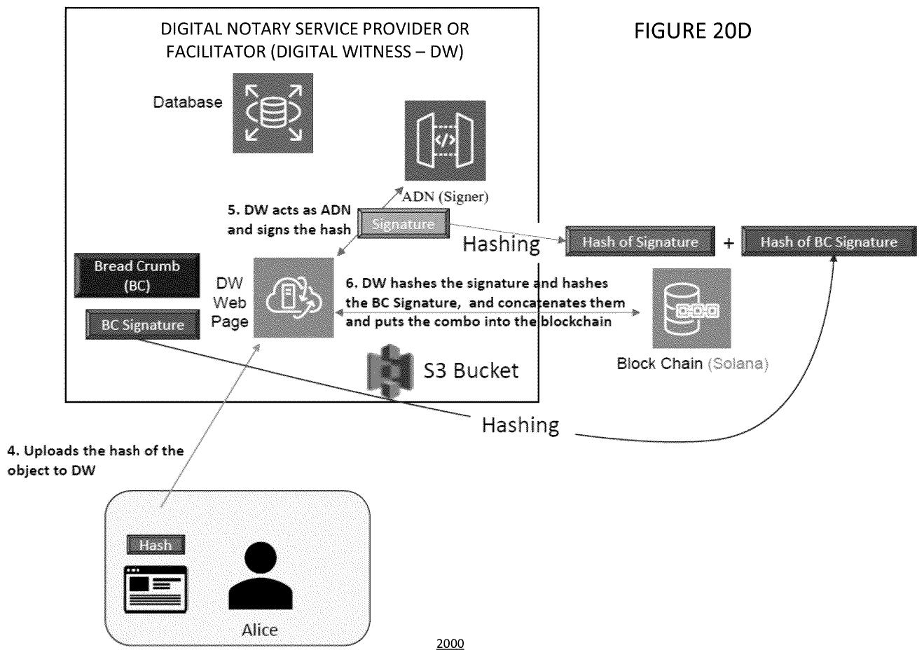

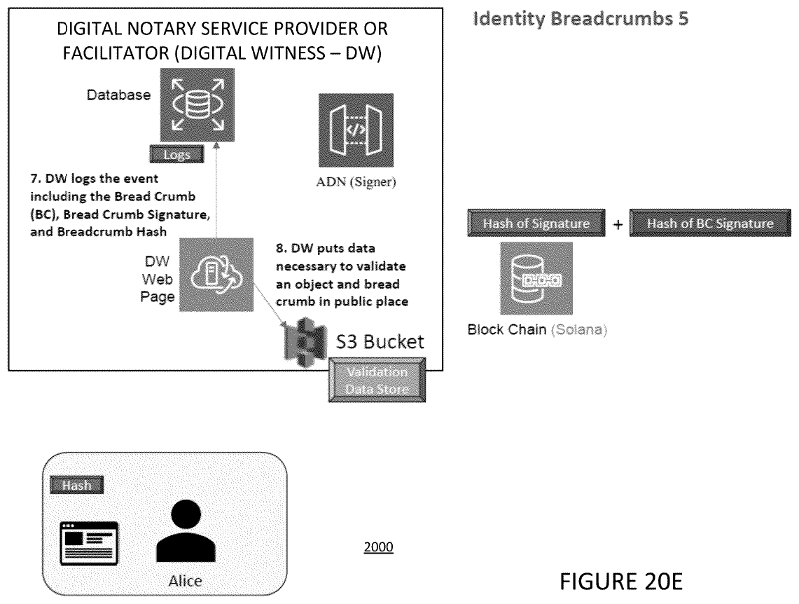

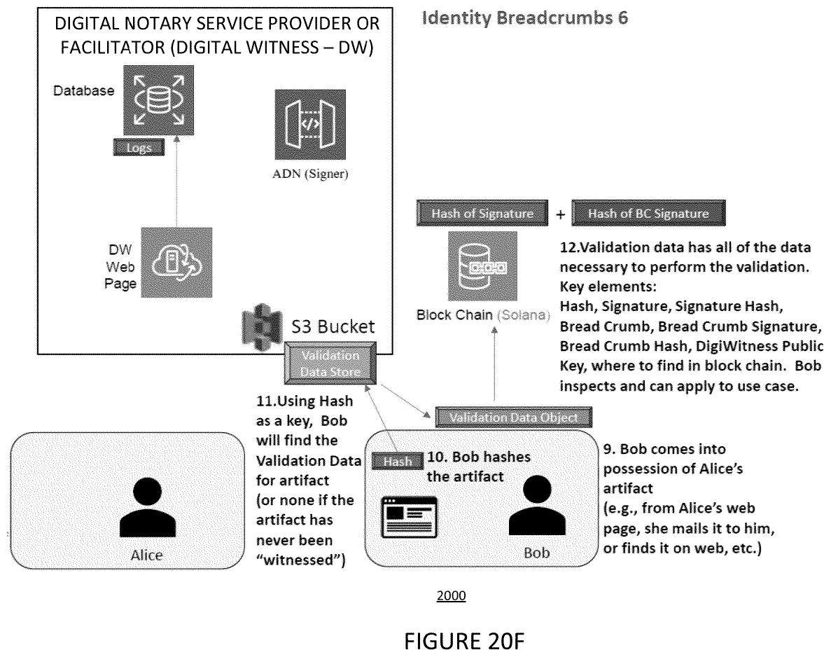

FIGS. 20A-20F illustrate operations in an example “breadcrumb” extension to example methods consistent with the present description. As this example will illustrate, the benefit of breadcrumbs is an association of the digital artifact and an account, such that the third party identity provider could be queried to validate the breadcrumb, and thereby identify the user (possessor) themselves that logged into the account. This may be important in situations that require this type of attribution. Although the digital notary service provider/facilitator can provide a process to include the identity breadcrumb, it preferably has no part in the validation of the breadcrumb. Instead, it is expected that the breadcrumb is significant only to the user (possessor) and third party identity provider. If, the user (possessor) desires, the third party identity provider can corroborate the user's association to the digital signing (witnessing) of the digital artifact without requiring involvement of the digital notary service provider/facilitator outside of the witnessing/validation process.

More specifically, referring first to FIG. 20A, Alice (1) authenticates to the web site/mobile application for DW, via a third party identity provider (e.g., an IDP such as Google, ID.me, etc.) with intention to witness an object (e.g., uses Google to authenticate to DW, or uses ID.me to authenticate to DW). The third party IDP (2) includes with the authentication approval(s), an “identity breadcrumb” or simply “breadcrumb” (i.e., a piece of information that will allow the third party IDP to validate a user's authentication). This breadcrumb might or might not be generally recognizable. FIG. 20B is similar to the example of FIGS. 17A-17F, in which Alice (1) uses web site/mobile app of the DW to create document hash on her local device which prevents the artifact from being transmitted over the network, and (2) uploads the hash to DW via web page. The DW (3) acts as ADN and signs the hash, and then (4) hashes the signature (to save space) and puts it into the blockchain. The breadcrumbing implementation differs because, referring first to FIG. 20C, the DW (3) acts as ADN and signs the breadcrumb. Referring next to FIG. 20D, Alice (4) uploads the hash of the artifact to DW. The DW then (5) acts as ADN and signs the hash, and (6) hashes both the signature (of the hash of the artifact) and the signature of the breadcrumb, concatenates these hashes, and puts the concatenated hashes into the blockchain. Referring next to FIG. 20E, DW (7) logs the event including the breadcrumb (BC), breadcrumb signature, and breadcrumb hash, and (8) puts data necessary to validate the artifact and the breadcrumb in a public place.

Assume that Bob wants to validate the artifact. Referring to FIG. 20F, Bob (9) comes into possession of Alice's artifact (e.g., from Alice's web page, she mails it to him, or finds it on web, etc.). Bob then (10) hashes the artifact and (11) using the hash as a key, Bob will find the validation data for artifact (or find nothing if the artifact has never been digitally notarized, or “witnessed”). In this example, the validation data (12) has all the data needed to perform the validation. For example, the validation data may include Hash, Signature, Signature Hash, Breadcrumb, Breadcrumb Signature, Breadcrumb Signature Hash, DW's Public Key (used for signing the artifact hash and for signing the breadcrumb), where to find in block chain, etc. Bob inspects and can apply to use case.

Note that in the example of operations illustrated in FIGS. 20A-20F, as will be apparent from the context, a “third party” might be a party independent of the digital notary service provider or facilitator (DW) and/or might be a party independent of the possessor of the digital artifact that had the digital artifact (or a fingerprint (e.g., hash) thereof) digitally notarized/signed/witnessed).

What is claimed is:

1. A computer-implemented method comprising:
a) creating, by a possessor of a digital artifact, a digital fingerprint from the digital artifact;
b) providing to a digital notary service provider or facilitator, (1) authentication information associated with the possessor of the digital artifact, and (2) the digital fingerprint, wherein the digital notary is not provided with the digital artifact, and wherein the digital notary service provider or facilitator either (A) provides a digital notary service and acts as a digital notary, or (B) facilitates a digital notary service through an independent third party acting as the digital notary;
c) responsive to receiving the authentication information, authenticating, by the digital notary service provider or facilitator, the possessor using authentication information;
d) responsive to receiving the digital fingerprint from the authenticated possessor, digitally signing, by the digital notary, the digital fingerprint, to generate a bonded fingerprint including a digital signature uniquely associated with the digital notary; and
e) storing at least one of (A) the bonded fingerprint, and/or (B) a fingerprint of the bonded fingerprint, on an immutable decentralized ledger registry.

2. The computer implemented method of claim 1, further comprising:
creating, a log of the digital signing of the digital fingerprint; and
storing log validation data including at least the log created, to be used in validating the log.

3. The computer implemented method of claim 2, wherein the log validation data further includes (1) the digital fingerprint of the digital artifact, (2) the bonded fingerprint, (3) the fingerprint of the bonded fingerprint, (4) a public key associated with the digital notary and the digital signing process used by the digital notary, and (5) a lookup information for retrieving the at least one of (A) the bonded fingerprint, and/or (B) a fingerprint of the bonded fingerprint from the immutable decentralized ledger registry.

4. The computer implemented method of claim 2, wherein the log validation data is indexed, at least in part, by the digital fingerprint of the digital artifact.

5. The computer implemented method of claim 4, further comprising:
f) receiving, by a third party, a purported copy of the digital artifact;
g) fingerprinting the purported copy of the digital artifact to generate a second fingerprint;
h) attempting to retrieve the log validation data using at least the second fingerprint;
i) responsive to a successful retrieval of the log validation data, attempting to validate the purported copy of the digital artifact using at least some of the log validation data, and
otherwise, responsive to an unsuccessful retrieval of the log validation data, informing the third party that the purported copy of the digital artifact cannot be validated.

6. The computer implemented method of claim 5, further comprising:
j) responsive to a successful attempt to validate the purported copy of the digital artifact using at least the log validation data, informing the third party that the purported copy of the digital artifact is valid, whereby the third party has at least three-way trust from (1) the party providing the purported copy of the digital artifact, (2) the digital notary, and (3) the immutable decentralized ledger registry, and
otherwise, responsive to an unsuccessful attempt to validate the purported copy of the digital artifact, informing the third party that the purported copy of the digital artifact cannot be validated.

7. The computer-implemented method of claim 1, further comprising:
f) generating, by the digital notary service provider or facilitator, an account activity log receipt including at least information about the possessor and the digital signing of the digital fingerprint by the digital notary;
g) providing to a second digital notary, by the digital notary service provider or facilitator, the account activity log receipt;
h) digitally signing, by the second digital notary, the account activity log receipt, to generate a bonded receipt; and
i) storing, (A) by the digital notary service provider or facilitator or (B) by the second digital notary, the bonded receipt or a digital fingerprint of the bonded receipt on a second immutable decentralized ledger registry that is controlled by neither the digital notary service provider or facilitator, nor the digital notary, nor by the second digital notary.

8. The computer-implemented method of claim 7, wherein the account activity includes an action and/or event within a fourth party system to instance a coincidental event with the receipting process.

9. The computer-implemented method of claim 7, further comprising:
j) receiving, by a third party, a purported copy of the digital artifact;
k) fingerprinting the purported copy of the digital artifact to generate a second fingerprint;
l) attempting to retrieve the log validation data using at least the second fingerprint;
m) responsive to a successful retrieval of the log validation data, attempting to validate the purported copy of the digital artifact using both (1) the log validation data and (2) the bonded receipt, and
otherwise, responsive to an unsuccessful retrieval of the log validation data, informing the third party that the purported copy of the digital artifact cannot be validated.

10. The computer-implemented method of claim 9, further comprising:
n) responsive to a successful attempt to validate the purported copy of the digital artifact using at least the log validation data and the bonded receipt, informing the third party that the purported copy of the digital artifact is valid, whereby the third party has at least four-way trust from (1) the party providing the purported copy of the digital artifact, (2) the digital notary (3) the second digital notary, and (4) the immutable decentralized ledger registry/registries, and
otherwise, responsive to an unsuccessful attempt to validate the purported copy of the digital artifact, informing the third party that the purported copy of the digital artifact cannot be validated.

11. The computer-implemented method of claim 1, wherein the authentication information associated with the possessor of the digital artifact includes an identity breadcrumb that allows a third party identification provider to later validate an identity of the possessor, the computer-implemented method further comprising:
digitally signing, by the digital notary, the identity breadcrumb, to generate a bonded identity breadcrumb,
wherein the act of storing at least one of (A) the bonded fingerprint, and/or (B) a fingerprint (e.g., hash) of the bonded fingerprint (e.g., for more efficient storage), on an immutable decentralized ledger registry, further stores at least one of (A) the bonded identity breadcrumb, and/or (B) a fingerprint of the bonded identity breadcrumb, in association with the at least one of (A) the bonded fingerprint, and/or (B) a fingerprint of the bonded fingerprint, on the immutable decentralized ledger registry.

12. The computer-implemented method of claim 1 wherein the digital artifact includes digital content and at least one of (A) a watermark and (B) meta data.

13. The computer-implemented method of claim 1 wherein the authentication information associated with the possessor is a private key, and wherein the private key has an associated public key.

14. The computer-implemented method of claim 1 wherein the bonded fingerprint is generated by encrypting the fingerprint with a private key of the digital notary.

15. The computer-implemented method of claim 1 wherein the immutable decentralized ledger registry is a blockchain.

16. The computer-implemented method of claim 1 wherein the bonded fingerprint is stored to the immutable decentralized ledger by the digital notary.

17. The computer-implemented method of claim 1 wherein the act of storing the bonded fingerprint on an immutable decentralized ledger registry includes (1) transmitting the bonded fingerprint from the digital notary to a user device of the possessor, and (2) storing the bonded fingerprint from the user device of the possessor to the immutable decentralized ledger.

18. The computer-implemented method of claim 1 further comprising:
determining, by a third party, whether or not a copy of the digital artifact has data integrity, by
retrieving the bonded fingerprint from the immutable decentralized ledger;
authenticating that the digital signature of the bonded fingerprint is uniquely associated with the digital notary; and
creating a digital fingerprint copy from the copy of the digital artifact; and
comparing the digital fingerprint copy created with the bonded fingerprint.

19. A digital notary service provider or facilitator system comprising:
a) at least one processor; and
b) at least one storage device storing processor-executable instructions which, when executed by the at least one processor of the first device, cause the at least one processor of the first device to perform steps of
1) receiving, from a possessor of a digital artifact, (1) a digital fingerprint of the digital artifact, and (2) authentication information associated with the possessor of the digital artifact, wherein the system is not provided with the digital artifact, and wherein the system either (A) provides a digital notary service and acts as a digital notary, or (B) facilitates a digital notary service through an independent third party acting as the digital notary;
2) responsive to receiving the authentication information, authenticating the possessor using authentication information;
3) responsive to receiving the digital fingerprint from the authenticated possessor, having the digital fingerprint digitally signed, by the digital notary, to generate a bonded fingerprint including a digital signature uniquely associated with the digital notary; and
4) storing at least one of (A) the bonded fingerprint, and/or (B) a fingerprint of the bonded fingerprint, on an immutable decentralized ledger registry.

20. A non-transitory computer-readable medium storing processor-executable instructions which, when executed by at least one processor, cause the at least one processor to perform a method comprising:
a) creating, by a possessor of a digital artifact, a digital fingerprint from the digital artifact;
b) providing to a digital notary service provider or facilitator, (1) authentication information associated with the possessor of the digital artifact, and (2) the digital fingerprint, wherein the digital notary is not provided with the digital artifact, and wherein the digital notary service provider or facilitator either (A) provides a digital notary service and acts as a digital notary, or (B) facilitates a digital notary service through an independent third party acting as the digital notary;
c) responsive to receiving the authentication information, authenticating, by the digital notary service provider or facilitator, the possessor using authentication information;
d) responsive to receiving the digital fingerprint from the authenticated possessor, digitally signing, by the digital notary, the digital fingerprint, to generate a bonded fingerprint including a digital signature uniquely associated with the digital notary; and
e) storing at least one of (A) the bonded fingerprint, and/or (B) a fingerprint of the bonded fingerprint, on an immutable decentralized ledger registry.
